(19) United States
(12) Patent Application Publication
(10) Pub. No.: US 2026/0222725 A1
(43) Pub. Date: Jul. 30, 2026

(54) EAR-CLIP EARPHONES

(71) Applicant: SHENZHEN SHOKZ CO., LTD., Shenzhen (CN)

(72) Inventors: Lei ZHANG, Shenzhen (CN); Chaojie CUI, Shenzhen (CN); Lei ZHONG, Shenzhen (CN); Jiang XU, Shenzhen (CN); Haochen LIU, Shenzhen (CN); Xin QI, Shenzhen (CN)

(73) Assignee: SHENZHEN SHOKZ CO., LTD., Shenzhen (CN)

(21) Appl. No.: 19/574,719

(22) Filed: Mar. 23, 2026

Related U.S. Application Data
(63) Continuation of application No. PCT/CN2024/138264, filed on Dec. 10, 2024.

(30) Foreign Application Priority Data
Dec. 11, 2023 (CN) 202311701969.7

(51) Int. Cl. H04R 1/10

(52) U.S. Cl. CPC H04R 1/105; H04R 1/1016; H04R 1/1058

(57) ABSTRACT

The present disclosure relates to an ear-clip earphone, comprising a sound production portion for inserting into a concha cavity, an abutting portion for abutting a rear side of an ear, and an ear hook connecting the sound production portion and the abutting portion. The abutting portion and the sound production portion are configured to clamp the ear-clip earphone onto a helix of the wearer. The sound production portion includes a first housing and a sound production assembly, the first housing including a first accommodation cavity accommodating the sound production assembly. The first housing is provided with a sound outlet hole, the ear hook includes a symmetry plane, an angle between a central axis of the sound outlet hole and the symmetry plane is in a range of 15-45 degrees, and in a wearing state, the sound outlet hole is located on a lower side of the symmetry plane.

### CROSS REFERENCE TO RELATED APPLICATIONS

This application is a continuation of International Application No. PCT/CN2024/138264 filed on Dec. 10, 2024, which claims priority to Chinese patent application No. CN202311701969.7, filed on Dec. 11, 2023, the entire contents of which are incorporated herein by reference.

### TECHNICAL FIELD

The present disclosure relates to the field of a sound production apparatus, and in particular, to an ear-clip earphone.

### BACKGROUND

Earphones have been widely used in daily life and can be used in conjunction with electronic devices, such as mobile phones and computers, to provide audio playback for users. Ear-clip earphones, a novel type of earphones, which are typically compact in size and can be clamped onto the wearer's helix, can provide a more comfortable wearing experience. When worn, the sound production portion of the ear-clip earphone is inserted into the wearer's concha cavity, imposing a certain size constraint on the sound production portion and further imposing a certain size constraint on a sound production assembly it can accommodate. Accordingly, the audio performance may be insufficient.

### SUMMARY

Embodiments of the present disclosure provide an ear-clip earphone, comprising a sound production portion, an abutting portion, and an ear hook. The sound production portion is inserted into a concha cavity of a wearer, the abutting portion abuts a rear side of an ear of the wearer, and the ear hook connects the sound production portion and the abutting portion. The abutting portion and the sound production portion are configured to clamp the ear-clip earphone onto a helix of the wearer. The sound production portion includes a first housing and a sound production assembly, the first housing includes a first accommodation cavity, and the sound production assembly is disposed within the first accommodation cavity. The first housing is provided with a sound outlet hole, and sound produced by the sound production assembly is output via the sound outlet hole. The ear hook includes a symmetry plane disposed along a length direction of the ear hook, an angle between a central axis of the sound outlet hole and the symmetry plane is in a range of 15 degrees to 45 degrees, and in a wearing state, the sound outlet hole is located on a lower side of the symmetry plane.

In the present disclosure, by setting the angle between the central axis of the sound outlet hole and the symmetry plane in a range of 15 degrees to 45 degrees, the sound outlet hole in the wearing state can be better directed to an ear hole, which is conducive to improving the listening effect of the ear-clip earphone.

### BRIEF DESCRIPTION OF THE DRAWINGS

FIG. 1 is a schematic diagram illustrating an exemplary structure of an ear-clip earphone according to one embodiment of the present disclosure;

FIG. 2 is a schematic diagram illustrating an exemplary cross-sectional view along a length direction of an ear hook according to one embodiment of the present disclosure;

FIG. 3 is a schematic diagram illustrating an exemplary cross-sectional view of a sound production portion with two speakers according to one embodiment of the present disclosure;

FIGS. 4-7 are schematic diagrams illustrating joint portions among a first rigid housing, a second rigid housing, and a first flexible body according to different embodiments of the present disclosure, or schematic diagrams illustrating joint surfaces among a third rigid housing, a fourth rigid housing, and a second flexible body;

FIGS. 8-12 are schematic diagrams illustrating exemplary cross-sectional views of a sound production portion according to different embodiments of the present disclosure;

FIG. 13 is a schematic diagram illustrating an exemplary cross-sectional view of a sound production portion with one speaker according to one embodiment of the present disclosure;

FIG. 14 is a schematic diagram illustrating an exemplary cross-sectional view of a sound production portion from another perspective according to one embodiment of the present disclosure;

FIG. 15 is a schematic diagram illustrating an exemplary cross-sectional view along a length direction of an ear hook according to one embodiment of the present disclosure;

FIG. 16 is a schematic diagram illustrating exemplary cross-sectional views of a third rigid housing, a fourth rigid housing, and a second flexible body according to different embodiments of the present disclosure;

FIG. 17 is a schematic diagram illustrating an exploded view of an abutting portion according to one embodiment of the present disclosure;

FIG. 18 is a schematic diagram illustrating an exploded view of an abutting portion according to another embodiment of the present disclosure;

FIG. 19 is a schematic diagram illustrating an exemplary cross-sectional view along a length direction of an ear hook according to another embodiment of the present disclosure;

FIG. 20 is a schematic diagram illustrating an exemplary three-dimensional structure of an earphone according to another embodiment of the present disclosure;

FIG. 21 is a schematic diagram illustrating an exemplary cross-sectional view along a length direction of an ear hook according to another embodiment of the present disclosure;

FIG. 22 is a schematic diagram illustrating an exemplary cross-sectional view of a sound production portion according to one embodiment of the present disclosure;

FIG. 23 is a schematic diagram illustrating a position of a sound outlet hole and a wearing state according to the present disclosure;

FIG. 24 is a schematic diagram illustrating wearing states at different angles of β according to the present disclosure;

FIG. 25 is a schematic diagram illustrating a human reference plane according to the present disclosure;

FIG. 26 is a graph illustrating frequency response curves at an ear canal opening corresponding to different angles of β when angle α is 0 degrees according to the present disclosure;

FIG. 27 is a graph illustrating frequency response curves at an ear canal opening corresponding to different angles of α when angle β is 0 degrees according to the present disclosure;

FIG. 28 is a graph illustrating wearing states corresponding to different angles of γ when a sound outlet hole is arranged laterally according to the present disclosure;

FIG. 29 is a graph illustrating frequency response curves at an ear canal opening corresponding to different angles of γ according to the present disclosure;

FIG. 30 is a graph illustrating a partial enlarged view of curves in FIG. 29 according to the present disclosure;

FIG. 31 is a graph illustrating a “free-field” sound field of “horn effect” according to the present disclosure;

FIG. 32 is a graph illustrating a “reflective-field” sound field of “horn effect” according to the present disclosure;

FIG. 33 is a diagram illustrating contour maps of sound pressure level corresponding to different values of angle θ and straight-line distance h-gap according to the present disclosure;

FIG. 34 is a diagram illustrating contour maps of sound pressure level corresponding to different values of angle θ and straight-line distance h-gap according to the present disclosure;

FIG. 35 is a diagram illustrating contour maps of sound pressure level corresponding to different values of angle θ and straight-line distance h-gap according to the present disclosure; and

FIG. 36 is a diagram illustrating sound leakage curves corresponding to different sound outlet hole positions.

### DETAILED DESCRIPTION

The present application is further described in detail below with reference to specific embodiments and accompanying drawings. Like reference numerals are used to designate similar elements in different embodiments. Many of the detailed descriptions provided in the following embodiments are intended to facilitate a better understanding of the present disclosure. However, those skilled in the art will readily recognize that certain features may be omitted in various circumstances, or may be replaced by other elements, materials, or methods. In certain cases, some operations related to the present disclosure are not explicitly shown or described in the present disclosure, in order to avoid obscuring the core aspects of the present disclosure with excessive detail. For those skilled in the art, detailed descriptions of such related operations are not necessary, as they can fully understand the relevant operations based on the descriptions provided herein and general knowledge in the art.

Moreover, the features, operations, or characteristics described in the present disclosure may be combined in any suitable manner to form various embodiments. Likewise, the steps or actions described in the methods may be reordered or adjusted in a manner that would be apparent to those skilled in the art. Therefore, the various sequences shown in the present disclosure and drawings are provided solely for the purpose of clearly describing a particular embodiment and do not imply a required order, unless explicitly stated that a specific sequence must be followed.

In the present disclosure, ordinal numbers assigned to components, such as “first” and “second,” are used solely to distinguish the described objects and do not imply any particular order or technical significance. Furthermore, unless otherwise specified, the terms “connected” or “coupled” as used in the present application encompass both direct and indirect connections (or couplings).

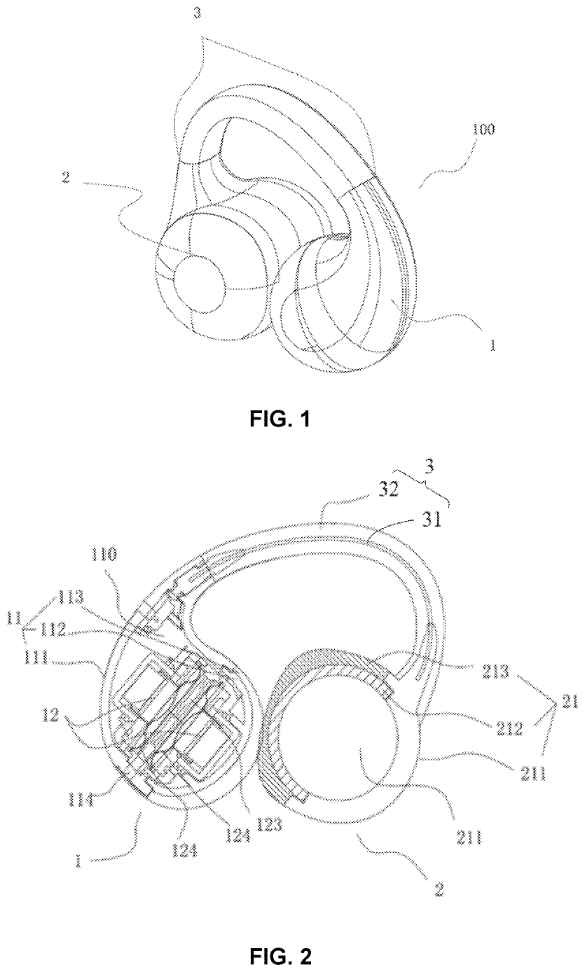

Referring to FIG. 1, the present disclosure provides an ear-clip earphone 100, comprising a sound production portion 1, an abutting portion 2, and an ear hook 3. The sound production portion 1 is inserted into a concha cavity of a wearer, the abutting portion 2 abuts a rear side of an ear of the wearer, and the ear hook 3 connects the sound production portion 1 and the abutting portion 2. The sound production portion 1 is a sound-playing device that converts an electrical signal into an acoustic signal and plays it to the wearer. The abutting portion 2 and the sound production portion 1 are configured to clamp the ear-clip earphone 1 onto a helix of the wearer. Specifically, the sound production portion 1 may abut an inner wall of the concha cavity, and the abutting portion 2 may abut against the rear side of the ear, such that the earphone clamps onto the helix to be securely worn on the ear. In some embodiments, the abutting portion 2 is used as a battery compartment for accommodating a battery or other components. It should be understood that the abutting portion 2 may not be used as a battery compartment for accommodating a battery; instead, a battery may be mounted on the sound production portion 1.

In one embodiment, referring to FIG. 2, the sound production portion 1 includes a first housing 11 and a sound production assembly 12. The sound production assembly 12 is a module capable of converting an electrical signal into an acoustic signal. Typically, the sound production assembly 12 is a speaker. The sound production assembly 12 may be provided with more than one speaker.

Referring to FIG. 2, the first housing 11 includes a first rigid housing 111, a second rigid housing 112, and a first flexible body 113. The first rigid housing 111 is connected to the ear hook 3, the second rigid housing 112 is disposed toward the concha cavity of the wearer in a wearing state, and the first flexible body 113 contacts the concha cavity of the wearer. The rigid material may be made of plastic, metal, or other materials capable of being used as a support material for the housing to provide better support and solidity to the internal structure (e.g., the sound production assembly 12) of the first housing 11. The first rigid housing 111 and the second rigid housing 112 enclose to form a first accommodation cavity 110, and the sound production assembly 12 is disposed within the first accommodation cavity 110. The first housing 11 is provided with a sound outlet hole 114, and sound wave emitted by the sound production assembly 12 may be transmitted to the wearer via the sound outlet hole 114. The first flexible body 113 covers an outer wall of the second rigid housing 112, and the first flexible body 113 may be made of silicone or other skin-friendly flexible material to improve the wearer contact comfort of the sound production portion 1.

The first rigid housing 111 and the second rigid housing 112 can provide better support for the internal structure. Usually, in the wearing state, the second rigid housing 112 may be oriented towards the concha cavity of the wearer. In the present disclosure, the first flexible body 113 covers the outer wall of the second rigid housing 112, so as to reduce the possibility of direct contact between the second rigid housing 112 and the wearer's skin, thereby improving the wearing comfort of the earphone.

Meanwhile, in the first housing 11, the first flexible body 113 mainly covers the second rigid housing 112, which basically does not affect the external structure and the internal space of the first rigid housing 111, thereby ensuring the utilization of the internal space of the first rigid housing 111. Specifically, the first flexible body 113 covers the outer wall of the second rigid housing 112, so that the second rigid housing 112 has a double-wall thickness, and an outer wall of the first rigid housing 111 is not covered by the first flexible body 113 and is exposed; or the first flexible body 113 extends from an outer side of the second rigid housing 112 to an outer side of the first rigid housing 111, and only a portion of the first rigid housing 111 that is close to the second rigid housing 112 is covered by the first flexible body 113 while the remaining portion of the outer wall of the first rigid housing 111 is exposed. Therefore, the first rigid housing 111 only has a single-wall thickness, so that it occupies less volume within the first accommodation cavity 110, thereby leaving more space for the sound production assembly 12. Such an arrangement allows accommodating a sound production assembly 12 with a larger diaphragm to achieve improved acoustic performance.

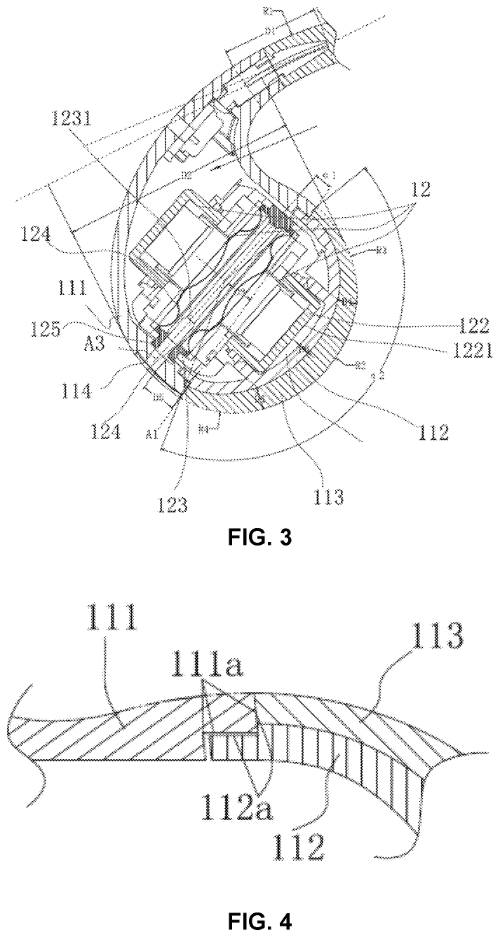

Referring to FIGS. 2 and 3, in some embodiments, a plane in which the outermost circular edge of an end surface of the first flexible body 113 is located is a first reference plane A1, and on a cross-section that is perpendicular to the first reference plane A1 and passes through a center (i.e., a center of the outermost circular edge of the end surface of the first flexible body 113) of the first reference plane A1, a covering region of the first flexible body 113 over the second rigid housing 112 is greater than or equal to 80% of a curved length segment (e.g., an outer contour line of the second rigid housing 112) of the second rigid housing 112. For example, the covering region is 80%, 85%, 90%, 95%, or 100% of the curved length segment of the second rigid housing 112, to ensure that the first flexible body 113 can cover a sufficiently large area of the second rigid housing 112 to reduce or eliminate the possibility of direct contact between the wearer and the second rigid housing 112.

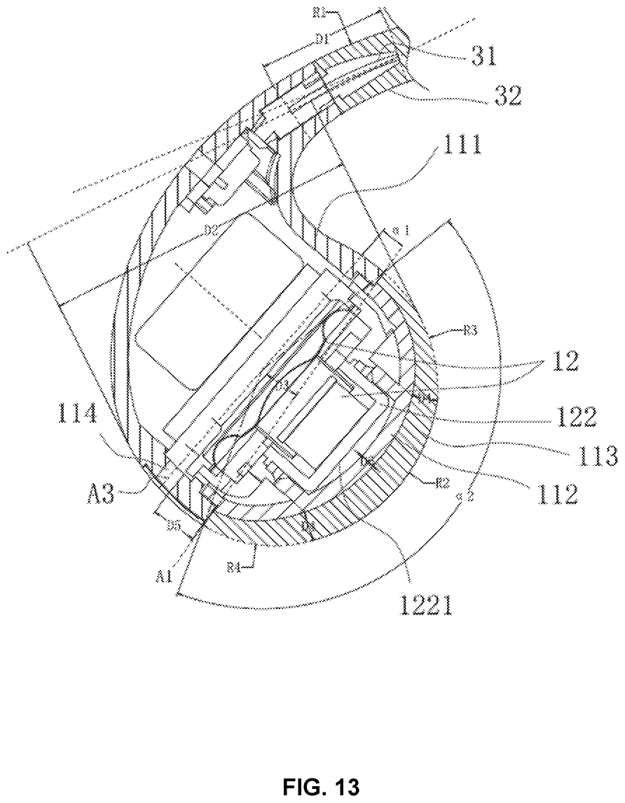

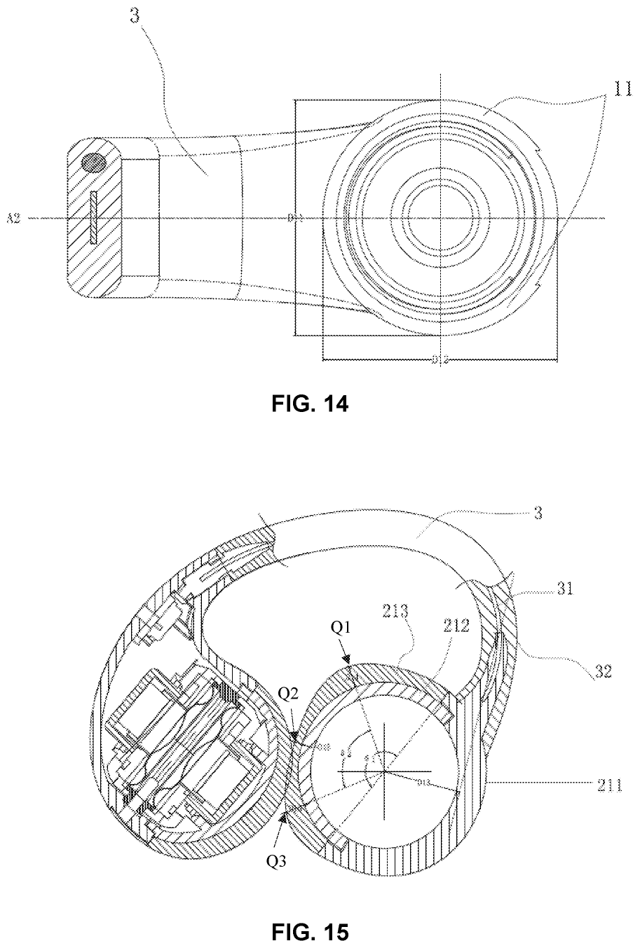

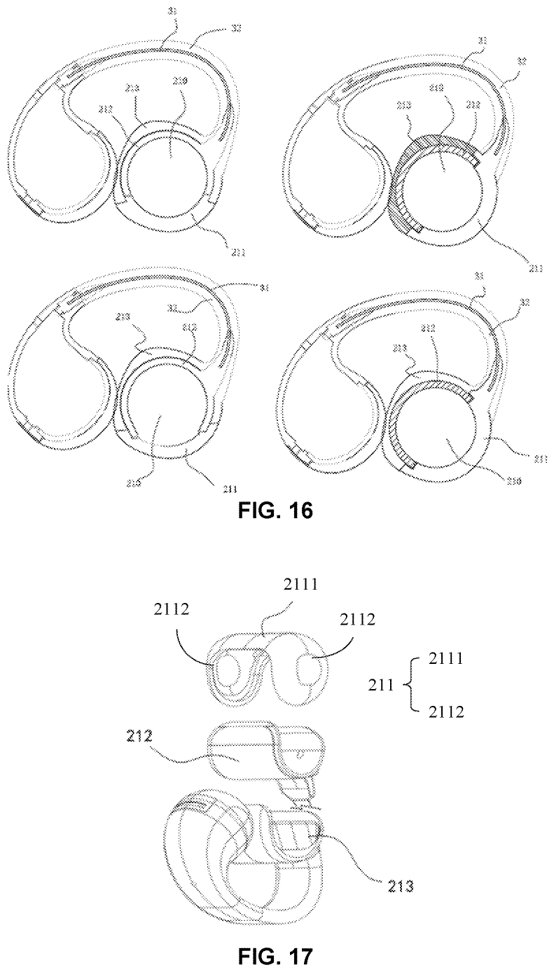

In some embodiments, referring to FIG. 2 and FIG. 13, a symmetry plane A2 (as indicated in FIG. 14) of the ear hook 3 intersects with the outermost circular edge of the end surface of the first flexible body 113 at two intersection points, and a cross-section that is perpendicular to the symmetry plane A2 and passes through the two intersection points may also be used as the first reference plane A1. On a cross-section that is perpendicular to the first reference plane A1 and passes through the center of the outermost circular edge of the end surface of the first flexible body 113, a covering region of the first flexible body 113 over the second rigid housing 112 is greater than or equal to 80% of a curved length segment (e.g., an outer contour line of the second rigid housing 112) of the second rigid housing 112. For example, the covering region is 80%, 85%, 90%, 95%, or 100% of the curved length segment of the second rigid housing 112. In this embodiment, a portion of the first flexible body 113 on the second rigid housing 112 is defined from another perspective, so that the first flexible body 113 can cover a sufficiently large area of the second rigid housing 112 to reduce or eliminate the possibility of direct contact between the wearer and the second rigid housing 112. The symmetry plane A2 refers to a plane in which the ear hook 3 is bilaterally symmetrical along a length direction of the ear hook 3. When the ear hook 3 is configured as an irregular and asymmetrical structure, a difference between two sides of the symmetry plane A2 of the ear hook 3 should be minimized among various possible division manners. For example, the symmetry plane A2 is determined based on the center (i.e., the center of the outermost circular edge of the end surface of the first flexible body 113) of the first reference plane A1, a center of a cross-section of the abutting portion 2 in a direction perpendicular to a length direction (the length direction herein will be described hereinafter) of the abutting portion 2, and a central point of the ear hook 3 along the length direction of the ear hook 3.

In some embodiments, referring to FIG. 3, on a first predetermined cross-section, a covering region of the first flexible body 113 over the second rigid housing 112 is greater than or equal to 80% of a curved length segment (e.g., an outer contour line of the second rigid housing 112) of the second rigid housing 112. For example, the covering region is 80%, 85%, 90%, 95%, or 100% of the curved length segment of the second rigid housing 112. In the present disclosure, when not otherwise specified, the term “first predetermined cross-section” may be the cross-section that is perpendicular to the first reference plane A1 and passes through the center of the outermost circular edge of the end surface of the first flexible body 113, or may be the symmetry plane A2. The term “first reference plane A1” may be the plane in which the outermost circular edge of the end surface of the first flexible body 113 is located, or the cross-section that is perpendicular to symmetry plane A2 and passes through the two intersection points between the symmetry plane A2 and the outermost circular edge of the end surface of the first flexible body 113. In this way, it is possible to enable the first flexible body 113 to cover a sufficiently large area of the second rigid housing 112 to reduce or eliminate the possibility of direct contact between the wearer and the second rigid housing 112.

In some embodiments, referring to FIGS. 4-7, an end portion of the second rigid housing 112 is spliced and fixed to an end portion of the first rigid housing 111. The end portion of the second rigid housing 112 is fixed to the end portion of the first rigid housing 111 by splicing to form a reliable fixation with a small occupied size. Such a splicing manner also facilitates assembly and reduces assembly procedures.

Specifically, during the production and processing of earphones, in order to ensure a more secure connection between the first flexible body 113 (usually made of silicone) and the second rigid housing 112, the first flexible body 113 needs to be injection-molded based on the second rigid housing 112. If the first flexible body 113 extends across a relatively large length over a splicing position between the first rigid housing 111 and the second rigid housing 112, the process usually requires that the injection molding is performed after a speaker is installed into the first housing and the splicing is completed. In such a case, components inside the first housing may suffer thermal damage during the injection molding process, which is disadvantageous to improving the yield rate of the product. Therefore, by disposing a main portion of the first flexible body 113 on the second rigid housing 112, silicone can be injection-molded onto the second rigid housing 112 in advance before assembly, thereby not only simplifying the process but also avoiding damage to the speaker that would otherwise be caused by injection molding after assembly.

In some embodiments, referring to FIG. 3, a portion of the outer wall of the second rigid housing 112 that is not covered by the first rigid housing 111 is covered by the first flexible body 113. Since the regions on the first housing 11 that typically contact the wearer are concentrated on the second rigid housing 112, this structure ensures that the second rigid housing 112 has no exposed regions, preventing the wearer from directly contacting the second rigid housing 112 and further improving wearing comfort.

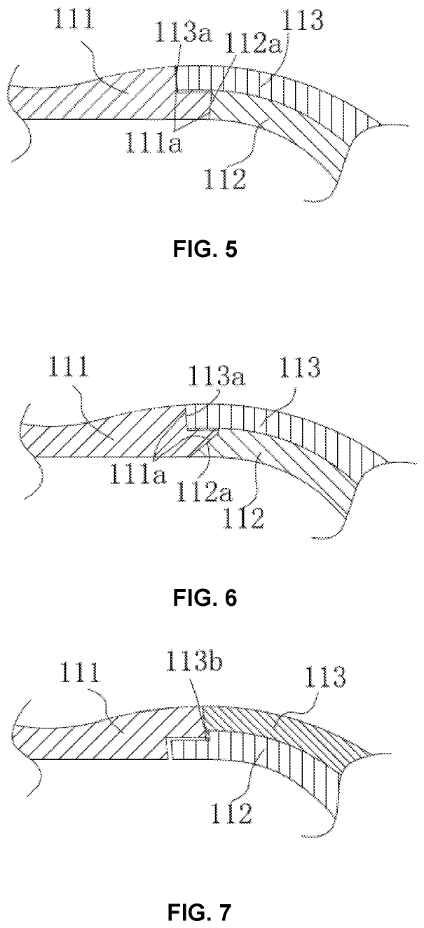

In some embodiments, referring to FIG. 5 and FIG. 6, the first flexible body 113 extends from the outer side of the second rigid housing 112 to the outer side of the first rigid housing 111 and covers a portion of the outer wall of the first rigid housing 111. A joint between the first rigid housing 111 and the second rigid housing 112 is typically a stress-concentrated region, and the portion of the outer wall of the first rigid housing 111 is covered by the first flexible body 113 such that the first flexible body 113 is fixed to both the first rigid housing 111 and the second rigid housing 112. Such an arrangement not only increases the fastening strength between the first rigid housing 111 and the second rigid housing 112, but also protects the stress-concentrated region. In addition, the first flexible body 113 may also cover a portion of the first rigid housing 111 that is close to the second rigid housing 112, so that when the wearer touches this portion, the wearer does not directly contact the second rigid housing 112, thereby improving wearing comfort. The first flexible body 113 may further cover the joint between the first rigid housing 111 and the second rigid housing 112, thereby improving the sealing and waterproofing effect.

In some embodiments, referring to FIG. 4 and FIG. 7, the first flexible body 113 does not cover the outer wall of the first rigid housing 111, so that the first flexible body 113 does not squeeze the interior space of the first rigid housing 111, ensuring that the first rigid housing 111 has a larger interior space.

In some embodiments, referring to FIG. 5, an end surface 113a of the first flexible body 113 extends to an end surface 111a of the first rigid housing 111, that is, the end surface 113a of the first flexible body 113 abuts the end surface 111a of the first rigid housing 111, and the flexible deformation property of the first flexible body 113 enables effective sealing and waterproofing with the end surface 111a of the first rigid housing 111.

In some embodiments, there is a gap between the end surface 113a of the first flexible body 113 and the end surface 111a of the first rigid housing 111, which provides a deformation space for the first flexible body 113 when the first flexible body 113 undergoes a micro-deformation when subjected to pressure.

In some embodiments, referring to FIG. 4, the end surface 113a of the first flexible body 113 is flush with the outermost circular edge of the end surface 113a of the first flexible body 113 along an inward-outward direction. An inner side refers to one side of the first housing 1 that the first accommodation cavity 110 is located, and an outer side refers to one side of the first housing 1 that faces away from the first accommodation cavity 110.

In some embodiments, there is a gap between the end surface 111a of the first rigid housing 111 and an end surface 112a of the second rigid housing 112, and a portion 113b of the first flexible body 113 extends into the gap and is clamped and fixed between the end surface 111a of the first rigid housing 111 and the end surface 112a of the second rigid housing 112. In this embodiment, the first flexible body 113 is enabled to more securely attach to the second rigid housing 112, forming an attaching manner that is more secure than one relying solely on adhesion. In addition to providing a more comfortable tactile experience, the first flexible body 113, together with the clamping action between the first rigid housing 111 and the second rigid housing 112, can also achieve improved sealing and waterproofing effect.

In the above embodiments, the end surface 111a of the first rigid housing 111 and the end surface 112a of the second rigid housing 112 are a pair of mutually matched planes which may be a plane, an inclined surface, a stepped surface, a folded surface, a wavy surface, or a combination thereof, to better realize the splicing of the first rigid housing 111 and the second rigid housing 112, thereby ensuring the sealing and waterproofing effect. The end surfaces of the first rigid housing 111 and the second rigid housing 112 are mutually matched, enabling adhesive fixation of contact surfaces. By employing more complex contact surface designs, for example, stepped surfaces, a bonding area is increased, thereby enhancing connection strength. Moreover, a combination of multiple end surface configurations can provide a multi-directional and more robust adhesive structure.

Further, in some embodiments, referring to FIG. 3, the sound production assembly 12 is mounted on the second rigid housing 112, and one end of the sound production assembly 12 facing the first rigid housing 111 protrudes from the second rigid housing 112. In this embodiment, by fully utilizing the parting structure of the first rigid housing 111 and the second rigid housing 112, the sound production assembly 12 is first mounted on the second rigid housing 112, and then the second rigid housing 112 together with components thereon are fixed to the first rigid housing 111, which reduces manufacturing difficulty, improves production efficiency, and increases yield.

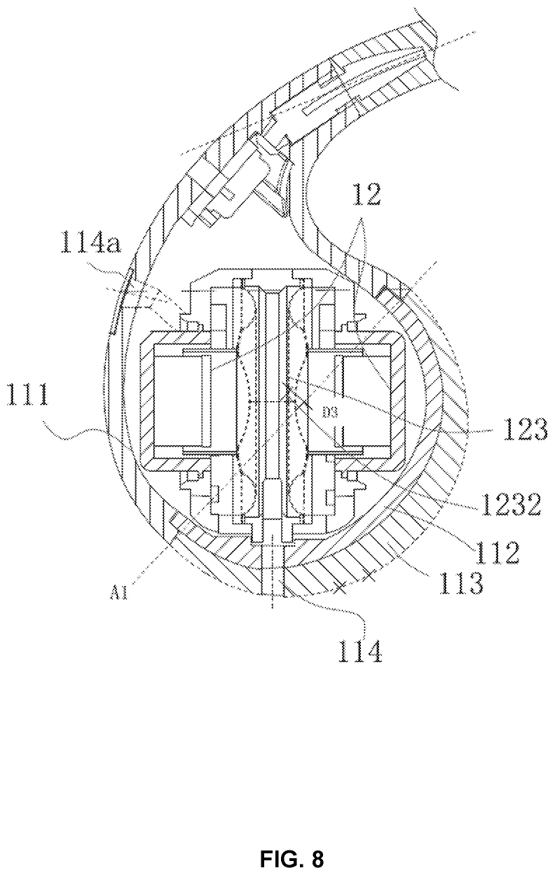

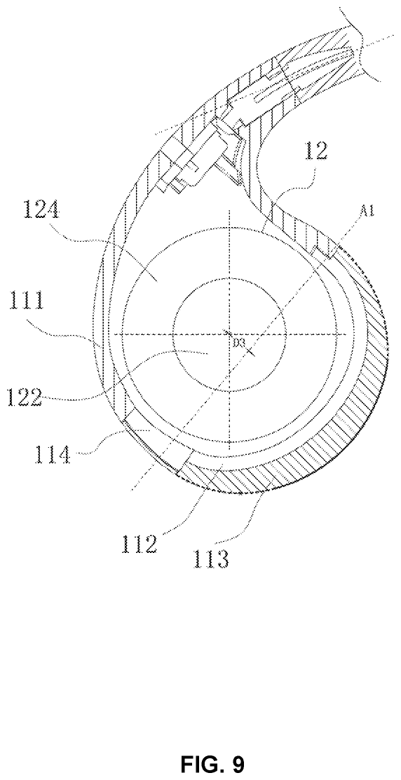

Further, the sound outlet hole 114 may be disposed on the first rigid housing 111 (as shown in FIG. 3), or may be disposed on the second rigid housing 112 and the first flexible body 113 (as shown in FIG. 8), or may be formed through the mating of the first rigid housing 111 with the second rigid housing 112 (as shown in FIG. 9).

In some embodiments, the sound outlet hole 114 is disposed on a portion of the first rigid housing 111 that is not covered by the first flexible body 113. In this way, the sound outlet hole 114 does not need to penetrate both the first rigid housing 111 and the second rigid housing 112, thereby avoiding surface unevenness of the sound outlet hole 114, which could otherwise affect the installation of a sound adjustment mesh and metal mesh. Moreover, disposing the sound outlet hole 113 on the first rigid housing 111 eliminates the need to create a hole in the first flexible body 113 and avoids concerns regarding the effect of the first flexible body 113 on the sound outlet hole 114, thereby reducing design and manufacturing costs.

In addition, since a larger internal accommodation space can be formed at the first rigid housing 111, a positioning boss may be disposed on a mounting bracket for a diaphragm at the sound outlet hole 114 without significantly increasing the external dimension of the first housing 11, which can increase the openness of an ear canal and enhances both the safety and comfort of the ear-clip earphone.

In some embodiments, referring to FIG. 3, an angle α1 between a central axis A3 of the sound outlet hole 114 and the first reference plane A1 is in a range of 3 degrees to 9 degrees. For example, the angle α1 is 3 degrees, 5 degrees, 7 degrees, or 9 degrees. With this arrangement, the sound outlet hole 114 does not extend across both the first rigid housing 111 and the second rigid housing 112 while being positioned relatively close to an ear hole, thereby increasing the listening volume.

In some embodiments, referring to FIG. 3, a distance D5 between one end of the sound outlet hole 114 that is close to the second rigid housing 112 and the first reference plane A1 is in a range of 1 mm to 3 mm. For example, the distance is 1 mm, 1.5 mm, 2 mm, 2.5 mm, or 3 mm. With this arrangement, the sound outlet hole 114 does not extend across both the first rigid housing 111 and the second rigid housing 112 while being positioned relatively close to the ear hole, and sufficient space is provided for adhesive paths among a sound outlet mesh, the first rigid housing 111, and a mounting bracket 123 for a diaphragm of a speaker.

In some embodiments, referring to FIG. 3, the first rigid housing 111 includes a region facing the ear hole when worn, and at least a portion of the sound outlet hole 114 is disposed within the region, so that the direction of sound propagation is as close as possible to the ear canal, which ensures that the sound from the sound outlet hole 114 reaches the wearer's ear hole promptly and accurately, providing improved audio quality and listening volume, thereby enhancing the overall sound performance of the earphone.

In some embodiments, referring to FIG. 3, the sound production assembly 12 includes a diaphragm 124, and an angle between an outer edge mounting plane of the diaphragm 124 (as shown in FIG. 3, an edge of the diaphragm 124 abuts the mounting bracket 123, and the outer edge mounting plane of the diaphragm 124 refers to a plane at this abutment position) and the first reference plane A1 is in a range of 3 degrees to 9 degrees. For example, the angle is 3 degrees, 5 degrees, 7 degrees, or 9 degrees. In this way, a speaker can be assembled with the first rigid housing 111 and the second rigid housing 112, respectively, before assembled with the first rigid housing 111, and a speaker does not extend across a parting line between the first rigid housing 111 and the second rigid housing 112, thereby facilitating assembly. With such an arrangement, while the sound outlet hole 114 is oriented toward the ear hole, a contact point between the concha cavity and the first flexible body 113 may be positioned close to the center position, allowing adaptation to a wider range of users and reducing the possibility of the concha cavity contacting the rigid housing.

In some embodiments, referring to FIG. 19, the ear hook 3 includes the symmetry plane A2 along the length direction of the ear hook 3, the sound production assembly 12 includes the diaphragm 124, and an angle between an outer edge mounting plane of the diaphragm 124 and the symmetry plane A2 is less than 10 degrees. With this arrangement, an outer edge of the speaker cuts the first housing 11 to form a curved line, creating a wedge-shaped space with the concha cavity. When the sound outlet hole 114 is disposed along the curved line, a horn-like structure is formed between the sound outlet hole 114 and the concha cavity. The concha cavity is utilized as a reflective surface to produce a horn effect, thereby increasing the listening volume.

The sound outlet hole 114 may be disposed on the second rigid housing 112 and the first flexible body 113, so that the sound outlet hole 114 may be positioned closer to the ear hole, which is conducive to enhancing the listening effect. The sound outlet hole 114 does not need to extend across both the first rigid housing 111 and the second rigid housing 112.

The sound outlet hole 114 may be arranged in a strip shape, wherein a length direction of the sound outlet hole is parallel or substantially parallel to the symmetry plane A2, and an angle α11 between the central axis A3 of the sound outlet hole 114 and the first reference plane A1 is in a range of 40 degrees to 80 degrees. For example, the angle α11 is 40 degrees, 50 degrees, 60 degrees, 70 degrees, or 80 degrees. In this way, a horn-like structure is formed between the sound outlet hole 114 and the concha cavity. The concha cavity is utilized as a reflective surface to produce a horn effect, thereby increasing the listening volume. The phrase “parallel or substantially parallel” in the present disclosure refers to that the length direction of the sound outlet hole 114 is parallel to the symmetry plane A2 with an allowed tolerance of ±15°.

The sound outlet hole 114 may be arranged in a strip shape, and the length direction of the sound outlet hole is parallel or substantially parallel to the symmetry plane A2. A distance between one end of the sound outlet hole that is close to the first rigid housing and the first reference plane may be in a range of 1 mm to 4 mm. For example, the distance is 1 mm, 2 mm, 2.5 mm, 3 mm, or 4 mm. In this way, it can make that the sound outlet hole 114 is relatively close to the ear hole, which is conducive to enhancing the horn effect. Additionally, it can prevent the sound outlet hole 114 from extending across both the first rigid housing 111 and the second rigid housing 112.

In some embodiments, referring to FIG. 3, a portion of a maximum radius of the sound production assembly 12 is located within the first rigid housing 111, and since the first rigid housing 111 is not covered by the first flexible body 113 or only a portion of the first rigid housing 113 is covered by the first flexible body 113, the space inside the first rigid housing 111 is therefore larger than the space inside the second rigid housing 112. By disposing a portion 125 of the maximum radius of the sound production assembly 12 within the first rigid housing 111, a sound production assembly 12 with a larger vibrator may be selected to obtain a better sound quality. Compared with the manner in which the portion 125 of the maximum radius of the sound production assembly 12 is disposed opposite to the first flexible body 113, such an arrangement can make full use of the space inside the earphone. As used herein, the radius of the sound production assembly 12 refers to a radius along a radial direction of the diaphragm of the speaker.

In some embodiments, referring to FIG. 3, the sound production assembly 12 includes the mounting bracket 123, a protruding structure (i.e., a structure indicated by marking 125) is disposed on one side of the mounting bracket 123. The protruding structure includes a sound transmission channel in communication with a speaker of the sound production assembly 12. Normally, the sound transmission channel needs to be at least partially aligned with the sound outlet hole 114. Therefore, in this embodiment, the portion 125 of the maximum radius of the sound production assembly 12 refers to a position where the protruding structure is located, and the protruding structure is disposed within the first rigid housing 111 to fully utilize the space inside the first rigid housing 111 to install a sound production assembly 12 with a larger vibrator.

In some embodiments, referring to FIG. 3, along a radial direction of the sound production assembly 12, a region in which the portion 125 of the maximum radius of the sound production assembly 12 is oriented is not covered by the first flexible body 113. This avoids the first flexible body 113 from compressing the internal space of the first rigid housing 111, ensuring that the first rigid housing 111 provides a larger internal accommodation space for use.

In some embodiments, referring to FIG. 3, the first rigid housing 111 includes a groove, and the portion 125 of the maximum radius of the sound production assembly 125 is accommodated within the groove. By disposing the groove on an inner wall of the first rigid housing 111, the internal space of the first rigid housing 111 can be enlarged, and thus, a larger sound production assembly 12 can be accommodated.

In some embodiments, the groove accommodates the positioning boss of the mounting bracket, and the positioning boss may also be used as a sound outlet channel on the mounting bracket for guiding the sound out of the sound outlet hole 114.

Further, the sound production assembly 12 may include one or more than two speakers. Based on the reasonable utilization of the internal space of the first rigid housing 111, the placement of the sound production assembly 12 may take various forms.

In some embodiments, referring to FIG. 3, a magnetic shield 122 of one speaker of at least one speaker is disposed within and toward the second rigid housing 112, the magnetic shield 122 toward the second rigid housing 112 includes an end surface 1221, and the end surface 1221 is a plane.

Further, in some embodiments, referring to FIG. 3, a plane in which the outermost circular edge of the end surface 113a of the first flexible body 113 is located is the first reference plane A1. On a cross-section that is perpendicular to the first reference plane A1 and passes through the center of the magnetic shield 122 facing the end surface 112a of the second rigid housing 112, a curvature radius of a region opposite to the end surface 1221 of the magnetic shield 122 on the second rigid housing 112 (e.g., an outer contour line of the second rigid housing 112) is greater than curvature radii of at least a portion of other regions located on two sides of it. With such an arrangement, the curvature radius of the second rigid housing 112 at this region is smaller, thereby leaving more space for the first flexible body 113 located outside, and increasing the thickness of the first flexible body 113 at this region without increasing the overall thickness of the first housing 11. This region is close to a contact center (i.e., a contact center between the wearer and the first flexible body 113), and a greater thickness at this region can improve wearing comfort.

In some embodiments, referring to FIG. 3, on a second predetermined cross-section, the curvature radius of the region opposite to the end surface 1221 of the magnetic shield 122 on the second rigid housing 112 (e.g., an outer contour line of the second rigid housing 112) is greater than the curvature radii of at least a portion of other regions located on two sides of it. In the present disclosure, when not otherwise specified, the term “second predetermined cross-section” may be a cross-section that is perpendicular to the first reference surface A1 and passes through the center of the magnetic shield 122 facing the send surface 112a of the second rigid housing 112, or may be the symmetry plane A2. In this way, it can make that the curvature radius of the second rigid housing 112 at this region is smaller, which leaves more space for the first flexible body 113 located outside, thereby increasing the thickness of the first flexible body 113 at this region without increasing the overall thickness of the first housing 11.

In some embodiments, referring to FIG. 3, the plane in which the outermost circular edge of the end surface 113a of the first flexible body 113 is located is the first reference plane A1, and on the cross-section that is perpendicular to the first reference plane A1 and passes through the center of the magnetic shield 122 facing the end surface 112a of the second rigid housing 112, a curvature radius R2 of a region opposite to the magnetic shield 122 on the first flexible body 113 (here refers to the outer contour line of the first flexible body 113) is in a range of 6 mm to 18 mm. For example, R2 is 6 mm, 8 mm, 10 mm, 12 mm, 14 mm, 16 mm, or 18 mm. Since this region is located close to the contact center (i.e., the contact center between the wearer and the first flexible body 113), a larger curvature radius increases the contact area and improves comfort.

In some embodiments, referring to FIG. 3, on the second predetermined cross-section, the curvature radius R2 of the region opposite to the magnetic shield 122 on the first flexible body 113 (e.g., the outer contour line of the first flexible body 113) is in a range of 6 mm to 18 mm. For example, R2 is 6 mm, 8 mm, 10 mm, 12 mm, 14 mm, 16 mm, or 18 mm. This region is close to the contact center, and a larger curvature radius increases the contact area and improves the comfort.

In some embodiments, referring to FIG. 3, the plane in which the outermost circular edge of the end surface 113a of the first flexible body 113 is located is the first reference plane A1, and on the cross-section that is perpendicular to the first reference plane A1 and passes through the center of the magnetic shield 122 facing the end surface 112a of the second rigid housing 112, a thickness of the region on the first flexible body 113 opposite to the end surface of the magnetic shield 122 is in a range of 0.8 mm to 2 mm. For example, the thickness is 0.8 mm, 1.0 mm, 1.5 mm, or 2.0 mm. Since this region is close to the contact center, a thicker silicone improves comfort.

In some embodiments, referring to FIG. 3, on the second predetermined cross-section, the thickness of the region on the first flexible body 113 opposite to the end surface of the magnetic shield 122 is in a range of 0.8 mm to 2 mm. For example, the thickness is 0.8 mm, 1.0 mm, 1.5 mm, or 2.0 mm. Since this region is close to the contact center, a thicker silicone can improve comfort.

In some embodiments, referring to FIG. 19, on the first predetermined cross-section, a curvature radius of a predetermined region C1 on the outer contour line of the first flexible body 113 is greater than a curvature radius of at least a portion of other regions located on two sides of the predetermined region C1. The predetermined region C1 is close to a contact center C2 between the first flexible body 113 and the concha cavity (i.e., the contact center between the wearer and the first flexible body 113). As shown in FIG. 19, in some embodiments, a distance between the contact center C2 and one end of the first flexible body 113 that is close to the ear hook 3 is roughly one-third of the length of the outer contour line of the first flexible body 113. Since the predetermined region C1 is close to the contact center C2, the predetermined region C1 with a larger curvature radius can increase the contact area with the concha cavity, thereby improving the wearing comfort.

The curvature radius of the predetermined region C1 may be in a range of 6 mm to 18 mm. For example, the curvature radius of the predetermined region C1 is 6 mm, 8 mm, 10 mm, 12 mm, 14 mm, 16 mm, or 18 mm. Since the predetermined region C1 is close to the contact center C2 (i.e., the contact center between the wearer and the first flexible body 113), the region with a larger curvature radius can increase the contact area and improve comfort.

The thickness of the first flexible body 113 in the predetermined region C1 may be in a range of 0.2 mm to 1 mm. For example, the thickness is 0.2 mm, 0.5 mm, 0.8 mm, or 1.0 mm. With such an arrangement, the wearing comfort can be maintained while avoiding increasing the overall dimension of the first housing.

In some embodiments, referring to FIG. 3, the sound production assembly 12 includes the intermediate mounting bracket 123 (i.e., a specific form of the mounting bracket 123 for two speakers) and two speakers. The two speakers are mounted on the intermediate mounting bracket 123, a sound transmission channel 1231 is between the diaphragms 124 of the two speakers, and the central axis A3 of the sound outlet hole 114 passes through the sound transmission channel 1231. The two-speaker design can increase the area of the diaphragm 124 under occupying the same radial area, thereby enhancing the BL value of the speaker under the same volume, which results in higher acoustic efficiency. In addition, the central axis A3 of the sound outlet hole 114 passes through the sound transmission channel 1231, making the path through which the sound exits the first accommodation cavity 110 more open and direct.

In some embodiments, referring to FIG. 3, the sound transmission channel 1231 is a common front cavity shared by the two speakers. In this embodiment, the structure of the shared front cavity can further reduce the volume occupied by the two speakers.

In some embodiments, the sound transmission channel 1231 is a rear cavity shared by the two speakers, and the sound outlet hole 114 and/or the sound transmission channel 1231 are provided with a waterproof and breathable membrane. The structure of the shared rear cavity can further reduce the volume occupied by the two speakers. Besides, the waterproof and breathable membrane disposed on the sound outlet hole 114 and/or the sound transmission channel 1231 can achieve a waterproof and dust-proof effect as much as possible without affecting the sound quality, thereby increasing the reliability of the earphone.

In some embodiments, referring to FIG. 3, the plane in which the outermost circular edge of the end surface 113a of the first flexible body 113 is located is the first reference plane A1, and on a cross-section that is perpendicular to the first reference plane A1 and passes through the center (i.e., the geometrical center of the mounting bracket 123) of the mounting bracket 123, an angle α2 between the center of the mounting bracket 123 and a line connecting two ends of the first flexible body 113 is in a range of 130 degrees to 160 degrees. For example, the angle α2 is 130 degrees, 140 degrees, 150 degrees, or 160 degrees. By setting a covering region of the first flexible body 113, a contact point between the concha cavity and a silicone segment is positioned closer to the center position, thereby reducing the possibility of the contact between the ear and a rigid housing segment.

In some embodiments, referring to FIG. 3, on the cross-section that is perpendicular to the first reference plane A1 and passes through the center (i.e., the geometric center of the mounting bracket 123) of the mounting bracket 123, the angle α2 between the center of the mounting bracket 123 and the line connecting two ends of the first flexible body 113 is in a range of 130 degrees to 160 degrees or greater than 160 degrees and less than or equal to 170 degrees. For example, the angle α2 is 130 degrees, 140 degrees, 150 degrees, 160 degrees, or 170 degrees. By setting the covering region of the first flexible body 113 in this manner, a contact point between the concha cavity and the silicone segment is positioned closer to the center position, thereby reducing the possibility of the contact between the ear and the rigid housing segment.

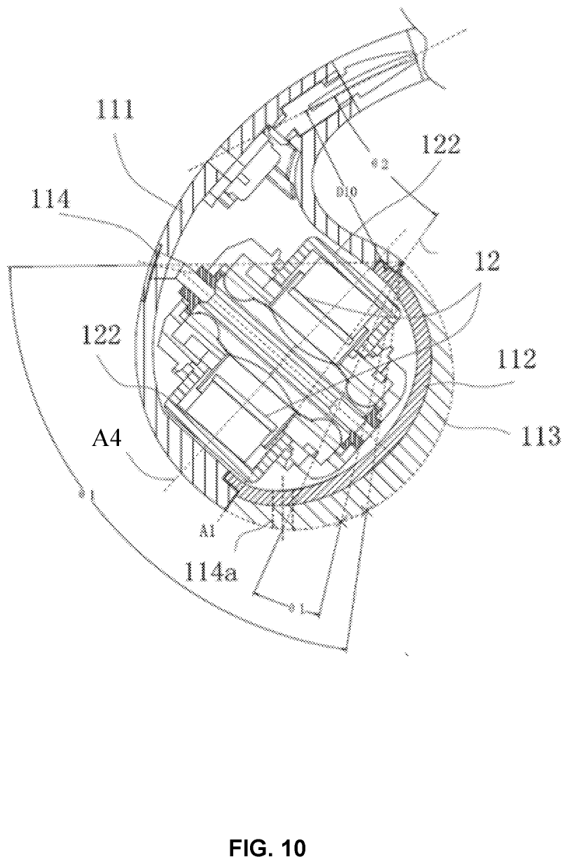

In some embodiments, referring to FIG. 10, the sound production assembly 12 includes the intermediate mounting bracket 123 (i.e., a specific form of a mounting bracket for two speakers) and two speakers, and the two speakers are mounted on the intermediate mounting bracket 123. A line A4 connecting the centers of the magnetic shields 122 of the two speakers passes through the first rigid housing 111, or the line A4 connecting the centers of the magnetic shields 122 of the two speakers A4 does not pass through the second rigid housing 112 and the first flexible body 113. In this embodiment, it can make that the center of the entire sound production assembly 12 is relatively close to the first rigid housing 111, thereby utilizing the internal space of the first rigid housing 111 efficiently.

In some embodiments, referring to FIG. 8, one side of the sound production assembly 12 at its widest point in the diametric direction and one side of the sound production assembly 12 at its widest point in the axial direction are both disposed opposite to the first rigid housing 111.

In some embodiments, referring to FIG. 3, two sides of the sound production assembly 12 at the widest point in the axial direction are disposed opposite to the first rigid housing 111. Since the space of the first rigid housing 111 is larger than the space of the second rigid housing 112, disposing the two sides of the sound production assembly 12 at the widest point in the axial direction opposite to the first rigid housing 111 allows for the selection of a sound production assembly 12 with a larger vibrator to obtain better sound quality.

In some embodiments, referring to FIG. 8, the sound production assembly 12 includes the mounting bracket 123 and at least one speaker, the speaker being mounted on the mounting bracket 123. A distance between a center 1232 of a surface of the mounting bracket 123 that is opposite to the magnetic shield 122 and the first reference surface A1 is in a range of 0.4 mm to 2 mm. For example, the distance is 0.4 mm, 0.8 mm, 1.2 mm, 1.5 mm, or 2 mm, and the first reference surface A1 is a plane in which the outermost circular edge of the end surface 113a of the first flexible body 113 is located; or the symmetry plane A2 of the ear hook 3 and the outermost circular edge of the end surface 113a of the first flexible body 113 intersect at two intersection points, and the first reference plane A1 is a plane that is perpendicular to the symmetry plane A2 and passes through the two intersection points.

In some embodiments, the sound production assembly 12 includes the mounting bracket 123 and at least one speaker, the speaker being mounted on the mounting bracket 123. The distance between the center 1232 of the surface of the mounting bracket 123 that is opposite to the magnetic shield 122 and the first reference plane is in a range of 0.4 mm to 2 mm or greater than 2 mm and less than or equal to 3 mm. For example, the distance is 0.4 mm, 0.8 mm, 1.2 mm, 1.5 mm, 2 mm, 1.5 mm, 2 mm, 2.5 mm, or 3 mm.

By disposing the sound production assembly in the first housing 11 in this manner, a relatively large portion of the volume of the sound production assembly 12 is distributed within the first rigid housing 111, thereby fully utilizing the relatively ample internal space of the first rigid housing 111, such that the first housing 11 can accommodate a sound production unit of a larger volume.

In some embodiments, as shown in FIG. 19, the ear hook 3 includes the symmetry plane A2 along the length direction of the ear hook 3, and the symmetry plane A2 and the outermost circular edge of the end surface of the first flexible body 113 intersect at two intersection points. On the symmetry plane A2, the ear hook 3 has an inner contour line, and on the inner contour line, there is a first reference point O1 in a region close to the helix of the wearer, wherein the inner contour line exhibits a localized maximum curvature radius at the first reference point O1. An angle α12 between the first reference point O1 and a line that connects the two intersection points is less than or equal to 15 degrees. For example, α12 is 3 degrees, 5 degrees, 8 degrees, 11 degrees, or 15 degrees.

In some embodiments, as shown in FIG. 19, the ear hook 3 includes the symmetry plane A2 along the length direction of the ear hook 3, and the symmetry plane A2 and the outermost circular edge of the end surface of the first flexible body 113 intersect at two intersection points. On the symmetry plane A2, there is a second reference point O2 on an outer wall of the sound production portion 1, and a distance between the second reference point O2 and an outer wall of the abutting portion 2 is shortest. An angle α13 between the second reference point O2 and the line that connects the two intersection points is in a range of 85 degrees to 115 degrees. For example, α13 is 85 degrees, 90 degrees, 100 degrees, 105 degrees, or 115 degrees.

In some embodiments, when the earphone is in a natural state (i.e., without external force applied), the sound production portion 1 and the abutting portion 2 are spaced apart on the symmetry plane A2. In this state, the second reference point O2 refers to an endpoint, on the sound production 1, of the shortest connection line between the sound production portion 1 and the abutting portion 2. In some embodiments, when the earphone is in a natural state (i.e., without external force applied), the sound production portion 1 and the abutting portion 2 abut against each other on the symmetry plane A2. In this state, the second reference point O2 refers to a midpoint of an arc segment, on the symmetry plane A2, of a contact region between the sound production portion 1 and the abutting portion 2. By configuring the wrapping angle of the first flexible body 113 in this manner, the contact region between the human ear and the first housing under most users or a standard head model can be entirely covered by the first flexible body 113, thereby ensuring wearing comfort, while also reserving more space for the first rigid housing 111 so that the internal cavity volume is not excessively occupied by the silicone region.

In some embodiments, referring to FIG. 10, an angle θ2 between a tangent line of the ear hook 3 and the first reference plane A1 is in a range of 18 degrees to 35 degrees. The first reference plane A1 is a plane in which the outermost circular edge of the end surface 113a of the first flexible body 113 is located; or the symmetry plane A2 of the ear hook 3 and the outermost circular edge of the end surface 113a of the first flexible body 113 intersect at two intersection points, and the first reference plane A1 is a plane that is perpendicular to the symmetry plane A2 and passes through the two intersection points.

By configuring the positional relationship between the ear hook 3 and the first housing 11 in this manner, an extension direction of the ear hook 3 after the earphone is worn can be approximately parallel to an extension direction of the helix, thereby reducing the compression degree of the ear hook 3 against the helix or avoiding such compression, and thus improving the wearing comfort of the ear-clip earphone.

In some embodiments, referring to FIG. 10, a distance D10 between the tangent line of the ear hook 3 and the first reference plane A1 is in a range of 6 mm to 8 mm. The first reference plane A1 is a plane in which the outermost circular edge of the end surface 113a of the first flexible body 113 is located; or the symmetry plane A2 of the ear hook 3 and the outermost circular edge of the end surface 113a of the first flexible body 113 intersect at two intersection points, and the first reference plane A1 is a plane that is perpendicular to the symmetry plane A2 and passes through the two intersection points.

In some embodiments, referring to FIG. 3, the plane in which the outermost circular edge of the end surface 113a of the first flexible body 113 is located is the first reference plane A1. On a cross-section that is perpendicular to the first reference plane A1 and passes through the center of the first reference plane A1, a length of the first flexible body 113(e.g., a length of the outer contour line of the first flexible body 113) is in a range of 16 mm to 25 mm. For example, the length is 16 mm, 19 mm, 21 mm, 23 mm, or 25 mm.

In some embodiments, referring to FIG. 3, on a first predetermined cross-section, the length of the outer contour line of the first flexible body is in a range of 16 mm to 25 mm. For example, the length is 16 mm, 19 mm, 21 mm, 23 mm, or 25 mm.

By configuring the length of the outer contour line of the first flexible body 113 in this manner, direct contact between the rigid housing and the skin in the wearing state can be avoided, thereby ensuring wearing comfort, while also reserving more space for the first rigid housing 111 so that the internal cavity volume is not excessively occupied by the silicone region.

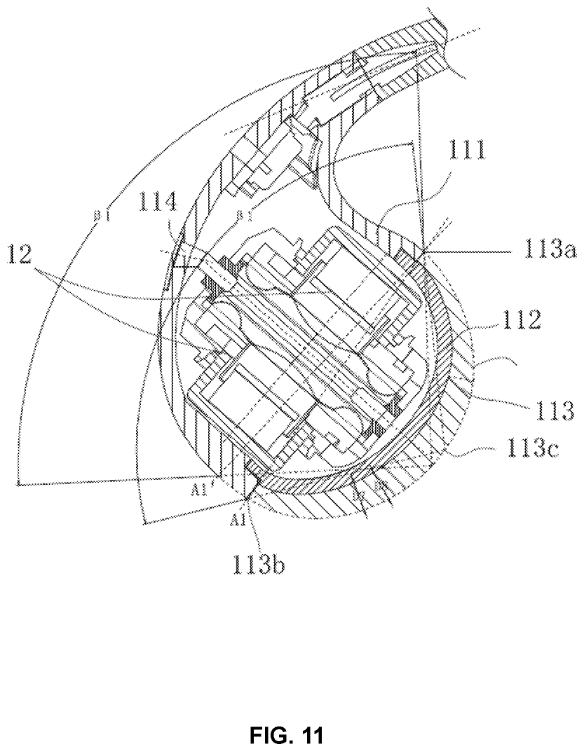

In some embodiments, referring to FIG. 11, a plane in which the outermost circular edge of the end surface 113a of the first flexible body 113 is located is the first reference plane A1. On a cross-section that is perpendicular to the first reference plane A1 and passes through the center of the first reference plane A1, one end of the first flexible body 113 that is closer to the ear hook 3 is the first end 113a, and one end of the first flexible body 113 that is away from the ear hook 3 is the second end 113b. At a region D8 located at one-third of a distance from the end surface of the second end 113b of the first flexible body 113, a thickness of the first flexible body 113 along a normal direction of an outer wall of the first flexible body 113 is in a range of 0.8 mm to 2.0 mm.

In some embodiments, referring to FIG. 11, on a first predetermined cross-section, one end of the first flexible body 113 that is closer to the ear hook 3 is the first end 113a, and one end of the first flexible body 113 that is away from the ear hook 3 is the second end 113b. At the region D8 located at one-third of the distance from the end surface of the second end 113b of the first flexible body 113, the thickness of the first flexible body 113 along the normal direction of the outer wall of the first flexible body 113 is in a range of 0.8 mm to 2.0 mm. For example, the thickness is 0.8 mm, 1.2 mm, 1.5 mm, 1.8 mm, or 2.0 mm.

According to a standard human head model, when the first housing 11 is near-spherical, an angle between a connection tangent line of the ear hook 3 and the first housing 11 and the first reference plane is in a range of 18 degrees to 35 degrees, a distance between a tangent line of the ear hook 3 and the first flexible body is in a range of 6 mm to 8 mm, and the length of the first flexible body is in a range of 16 mm to 25 mm, a central contact region between the first housing 11 and the human head model is located at one-third of the distance of the first flexible body from the end surface of the first end of the first flexible body. By setting the thickness of the first flexible body at this region, the central contact region is positioned close to a length midpoint of the first flexible body, thereby reducing the possibility of the human ear contacting the rigid housing, while also minimizing the volume of the first housing 11 to ensure the effect of open listening.

In some embodiments, referring to FIG. 19, a central contact region C2 between the first housing 11 and the human head model is located at one-third of the distance of the first flexible body 113 from the end surface of the first end 113a of the first flexible body 113. On a first predetermined cross-section, at the region at one-third of the distance of the first flexible body 113 from the end surface of the first end 113a of the first flexible body 113, the thickness of the first flexible body 113 along the normal line of the outer wall of the first flexible body 113 is in a range of 0.8 mm to 2.0 mm. For example, the thickness is 0.8 mm, 1.2 mm, 1.5 mm, 1.8 mm, or 2.0 mm. By setting the thickness of the first flexible body at this region, the central contact region is positioned close to the length midpoint of the first flexible body, thereby reducing the possibility of the human ear contacting the rigid housing, while also minimizing the volume of the first housing 11 to ensure the effect of open listening.

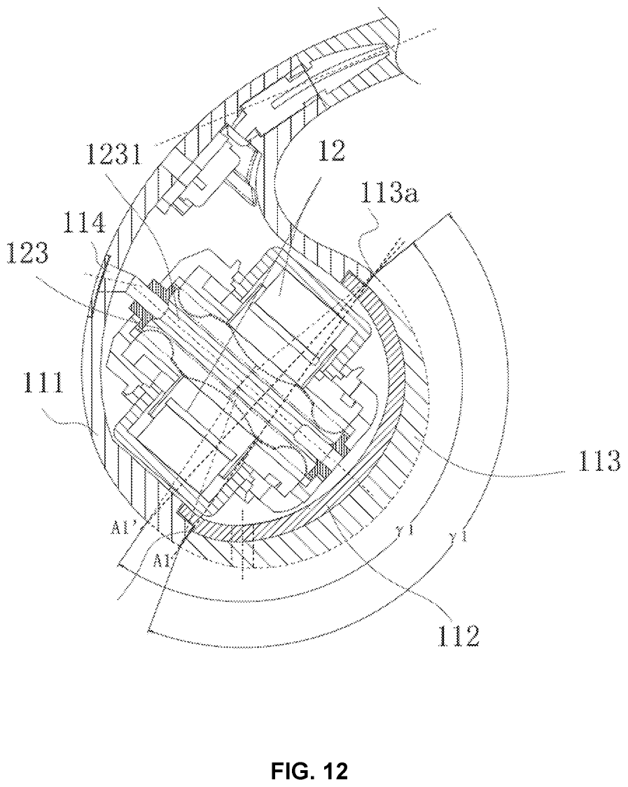

In some embodiments, referring to FIG. 12, a plane in which the outermost circular edge of the end surface 113a of the first flexible body 113 is located is the first reference plane A1. On a cross-section that is perpendicular to the first reference plane A1 and passes through the center of the first reference plane A1, a three-point arc is fitted based on two endpoints on the outer wall of the first flexible body 113 and a midpoint of the first flexible body 113. The center of the three-point arc is used as a cavity center, and an angle γ1 between two lines that connect the cavity center and the two endpoints of the first flexible body 113 is in a range of 145 degrees to 170 degrees. For example, the angle γ1 is 145 degrees, 150 degrees, 155 degrees, 160 degrees, 165 degrees, or 170 degrees.

In some embodiments, on a first predetermined cross-section, a three-point arc is fitted based on two endpoints on the outer wall of the first flexible body 113 and the midpoint of the first flexible body. The center of the three-point arc is used as a cavity center, and an angle γ1 between two lines that connect the cavity center and the two endpoints of the first flexible body 113, respectively, is in a range of 145 degrees to 170 degrees (including endpoint values), or greater than 170 degrees and less than or equal to 178 degrees. For example, the angle γ1 is 145 degrees, 150 degrees, 155 degrees, 160 degrees, 165 degrees, 170 degrees, 172 degrees, 175 degrees, or 178 degrees.

In some embodiments, referring to FIG. 11, a plane in which the outermost circular edge of the end surface 113a of the first flexible body 113 is located is the first reference plane A1. On a cross-section that is perpendicular to the first reference plane A1 and passes through the center of the first reference plane A1, an angle β1 between lines that connect two endpoints on the outer wall of the first flexible body 113 and a midpoint 113 c of the first flexible body 113, respectively, is in a range of 90 degrees to 100 degrees. For example, the angle β1 is 90 degrees, 92 degrees, 94 degrees, 96 degrees, 98 degrees, or 100 degrees.

In some embodiments, on a first predetermined cross-section, an angle β1 between lines that connect two endpoints on the outer wall of the first flexible body 113 and the midpoint 113 c of the first flexible body 113, respectively, is in a range of 90 degrees to 100 degrees. For example, the angle β1 is 90 degrees, 92 degrees, 94 degrees, 96 degrees, 98 degrees, or 100 degrees.

By setting the wrapping angle of the first flexible body 113 in this manner, the contact region between the human ear and the first housing under most individuals or a standard human head model is covered by the first flexible body 113, thereby ensuring comfort, while also providing more space for the first rigid housing 111 so that the volume of the inner cavity is not excessively occupied by the silicone region.

In some embodiments, referring to FIG. 10 (positions of two sound outlet holes are shown in FIG. 10, including a position 114 and an optional position 114a), a plane in which the outermost circular edge of the end surface 113a of the first flexible body 113 is located is the first reference plane A1. On a cross-section that is perpendicular to the first reference plane A1 and passes through the center of the first reference plane A1, one end of the first flexible body 113 that is closer to the ear hook 3 is the first end 113a, and one end of the first flexible body 113 that is away from the ear hook 3 is the second end 113b. An angle θ1 between a line that connects the first end 113a and a contact center on the outer wall of the first flexible body 113 and a line that connects the first end 113a and a center of upper and lower positions of the sound outlet hole 114 is in a range of 10 degrees to 85 degrees. For example, the angle θ1 is 10 degrees, 20 degrees, 30 degrees, 50 degrees, 70 degrees, 80 degrees, or 85 degrees.

In some embodiments, on a first predetermined cross-section, one end of the first flexible body 113 that is closer to the ear hook 3 is the first end 113a, and one end of the first flexible body 113 that is away from the ear hook 3 is the second end 113b. An angle θ1 between a line that connects the first end 113a and a contact center on the outer wall of the first flexible body 113 and a line that connects the first end 113a and the center of the upper and lower positions of the sound outlet hole 114 is in a range of 10 degrees to 85 degrees. For example, the angle θ1 is 10 degrees, 20 degrees, 30 degrees, 50 degrees, 70 degrees, 80 degrees, or 85 degrees. By positioning the sound outlet hole 114 in this manner, the directionality of the sound outlet hole 114 toward the ear hole can be improved, thereby achieving a greater listening volume.

In some embodiments, the central contact region between the first housing 11 and the human head model is located at one-third of the distance of the first flexible body 113 from the end surface of the first end of the first flexible body 113. An angle between a line that connects one endpoint of the first reference plane that is closer to the ear hook and the center of the sound outlet hole 114 and a line that connects the endpoint of the first reference surface plane that is closer to the ear hook and the contact center is in a range of 10 degrees to 85 degrees.

When the first housing 11 is near-spherical, an angle between a connection tangent line of the ear hook 3 and the first housing 11 and the first reference plane is in a range of 18 degrees to 35 degrees, and a distance between the tangent line of the ear hook 3 and the first reference plane is in a range of 6 mm to 8 mm, positioning the sound outlet hole 114 in this manner can enable the normal direction of the sound outlet hole 114 to direct toward the ear hole, thereby achieving a greater listening volume.

In some embodiments, an angle between the mounting plane in which the diaphragm of the speaker is located and the symmetry plane along the length direction of the ear hook is less than 10 degrees. With this arrangement, an outer edge of the speaker cuts the first housing 11 to form a curved line, creating a wedge-shaped space with the concha cavity. When the sound outlet hole 114 is disposed along the curved line, a horn-like structure is formed between the sound outlet hole 114 and the concha cavity. The concha cavity is utilized as a reflective surface to produce a horn effect, thereby increasing the listening volume.

In some embodiments, the first flexible body 113 and the second rigid housing 112 are integrally machined or fixedly connected in a one-piece structure. The two can therefore be pre-machined as a single component and then mounted together to the first rigid housing 111.

In some embodiments, referring to FIG. 14, on a cross-section that passes through a plane in which the outermost circular edge of the end surface 113a of the first flexible body 113 is located, a ratio between a width D11 and a width D12 of the first housing 11 along two mutually perpendicular directions is in a range of 0.8 to 1.2. In this embodiment, the ratio in a range of 0.8 to 1.2 allows the entire first accommodation cavity 110 to approximate a spherical shape, thereby providing a vibrator cavity that is more suitable for wearing, has a relatively large volume, and is easy to assemble.

In some embodiments, on a first predetermined cross-section, the ratio between the width D11 and the width D12 of the first housing 11 along two mutually perpendicular directions is in a range of 0.8 to 1.2. In this embodiment, the ratio in a range of 0.8 to 1.2 allows the entire first accommodation cavity 110 to approximate a spherical shape, thereby providing a vibrator cavity that is more suitable for wearing, has a relatively large volume, and is easy to assemble.

In some embodiments, in the wearing state, a thickness of a contact region on the first flexible body 113 that contacts the concha cavity is greater than thicknesses of other regions. On one hand, the contact region with a greater thickness can improve wearing comfort. On the other hand, other regions with a smaller thickness are favorable for controlling the overall size of the sound production portion 1.

In some embodiments, according to a standard human head model, the first housing 11 has a size and a shape that can ensure it to be worn without blocking the ear hole of the wearer.

In some embodiments, the abutting portion 2 includes a second housing 21. The second housing 21 includes a third rigid housing 211, a fourth rigid housing 212, and a second flexible body 213. The fourth rigid housing 212 is disposed toward a rear side of the wearer's ear, the second flexible body 213 contacts the rear side of the wearer's ear, and the third rigid housing 211 and the fourth rigid housing 212 enclose to form a second accommodation cavity 210; the second flexible body 213 covers an outer wall of the fourth rigid housing 212. An outer wall of the third rigid housing 211 is not covered by the second flexible body 213 and is exposed, or the second flexible body 213 extends from an outer side of the fourth rigid housing 212 to an outer side of the third rigid housing 211 and covers a portion of the outer wall of the third rigid housing 211, so that the remaining portion of the outer wall of the third rigid housing 211 is exposed.

The ear-clip earphone 100 according to the above-described embodiment comprises the sound production portion 1, the abutting portion 2, and an ear hook connecting the sound production portion 1 and the abutting portion 2. The abutting portion 2 includes the third rigid housing 211, the fourth rigid housing 212, and the second flexible body 213. The third rigid housing 211 and the fourth rigid housing 212 enclose to form the second accommodation cavity 210. The third rigid housing 211 and the fourth rigid housing 212 can support the internal structure. Usually, when worn, the fourth rigid housing 212 may face toward the rear side of the wearer's ear, and in the present disclosure, the second flexible body 213 covering the outer wall of the fourth rigid housing 212 reduces the possibility of direct contact between the fourth rigid housing 212 and the skin of the wearer, thereby improving the wearing comfort. In addition, in the abutting portion 2, the second flexible body 213 mainly covers the fourth rigid housing 212, which basically does not affect the external structure and the internal space of the third rigid housing 211, thereby ensuring the utilization of the internal space of the third rigid housing 211.

Furthermore, in some embodiments, referring to FIG. 2 and FIG. 14, the abutting portion 2 includes the second housing 21. The second housing 21 includes the third rigid housing 211, the fourth rigid housing 212, and the second flexible body 213. The fourth rigid housing 212 is disposed toward the rear side of the wearer's ear when the earphone is worn, the second flexible body 213 contacts the rear side of the wearer's ear, and the third rigid housing 211 and the fourth rigid housing 212 enclose to form the second accommodation cavity 210; the second flexible body 213 covers the outer wall of the fourth rigid housing 212. A thickness of a region on the fourth rigid housing 212 covered by the second flexible body 213 is less than the thickness of the third rigid housing 211. Since the second flexible body 213 covers the outer wall of the fourth rigid housing 212, a portion of the fourth rigid housing 212 has a double-wall thickness. Accordingly, since the outer wall of the third rigid housing 211 is not covered by the second flexible body 213, a portion of the third rigid housing 211 only has a single-wall thickness, so that the portion of the third rigid housing 211 occupies less volume of the second accommodation cavity 210, leaving more space for the battery, thereby accommodating a larger battery to increase the earphone's battery life.

Similar to the structure of the first rigid housing 111 and the second rigid housing 112, in some embodiments, an end portion of the third rigid housing 211 is spliced and fixed to an end portion of the fourth rigid housing 212; a portion of the outer wall of the fourth rigid housing 212 that is not blocked by the third rigid housing 211 is covered by the second flexible body 213.

Similar to the structure of the first rigid housing 111 and the second rigid housing 112, the second flexible body 213 extends from the outer side of the fourth rigid housing 212 to the outer side of the third rigid housing 211 and covers the portion of the outer wall of the third rigid housing 211.

Similar to the structure of the first rigid housing 111 and the second rigid housing 112, an end surface of the second flexible body 213 extends to an end surface of the third rigid housing 211, and due to the flexible deformation property of the second flexible body 213, the second flexible body 213 and the end surface of the third rigid housing 211 can cooperate to form a better sealing waterproof effect.

Similar to the structure of the first rigid housing 111 and the second rigid housing 112, there is a gap between the end surface of the second flexible body 213 and the end surface of the third rigid housing 211, which allows the second flexible body 213 to have sufficient deformation space when subjected to extrusion deformation.

Similar to the structure of the first rigid housing 111 and the second rigid housing 112, the end surface of the second flexible body 213 is flush with the outermost circular edge of the end surface of the fourth rigid housing 212 along an inward-outward direction, or the second flexible body 213 does not cover the outer wall of the third rigid housing 211.

Similar to the structure of the first rigid housing 111 and the second rigid housing 112, there is a gap between the end surface of the third rigid housing 211 and the end surface of the fourth rigid housing 212, and the second flexible body 213 extends into the gap and is clamped and fixed between the end surface of the third rigid housing 211 and the end surface of the fourth rigid housing 212. Such an arrangement allows the second flexible body 213 to fit more closely with the fourth rigid housing 212, and the clamping action between the third rigid housing 211 and the fourth rigid housing 212 also provides an improved sealing and waterproof effect.

Similar to the structure of the first rigid housing 111 and the second rigid housing 112, the end surface of the third rigid housing 211 and the end surface of the fourth rigid housing 212 are a plane, an inclined surface, a stepped surface, a folded surface, a wavy surface that are mutually matched, or a combination thereof.

In some embodiments, the second housing 21 includes an elongated strip structure. On a cross-section that is perpendicular to the length direction of the second housing 21, a ratio of a line that connects two ends of the second flexible body 213 to a radial dimension of the housing is greater than or equal to 0.9 and less than or equal to 1. That is, the ratio of the line that connects the two ends of the second flexible body 213 to the largest radial dimension of the housing is in a range of 0.9 to 1. For example, the ratio is 0.9, 0.92, 0.94, 0.96, 0.98, or 1. This arrangement limits a covering region of the second flexible body 213 over the second housing 21 to within a certain range. If the covering region is too small, a covered area becomes small, causing the wearer's ear to contact the housing during use. Conversely, if the covering region is too large, the phenomenon “over-coverage” occurs, in which portions of the housing that do not contact the ear are also covered, thereby compressing the volume of the second accommodation cavity 210 and reducing space utilization efficiency. In the embodiment of the present disclosure, it should be noted that the value described as being in a range of A to B refers to a value located in the range from A to B, including the endpoint values A and B.

In some embodiments, referring to FIG. 15, the second housing 21 includes an elongated strip structure, and on a cross-section that is perpendicular to the length direction of the second housing 21, a distance D13 between a midpoint of an outer wall of the second flexible body 213 and the tangent line of the ear hook 3 is in a range of 9 mm to 13 mm. A distance greater than 9 mm ensures that, when the second housing 21 extends into a wearing position inside the ear, the ear hook 3 does not compress the helix; while a distance not exceeding 13 mm limits the size of the earphone, preventing it from becoming too large and causing the center of gravity to shift outward, which could result in the earphone easily falling off.

In some embodiments, referring to FIG. 17, the third rigid housing 211 is a U-shaped structure, that is, the third rigid housing 211 includes a connecting wall 2111 and two side walls 2112. The two side walls 2112 are disposed at opposite ends of the connecting wall 2111, and the fourth rigid housing 212 is located between the two side walls 2112 of the U-shaped structure. The connecting wall 2111 is spliced with the fourth rigid housing 212 to form an annular peripheral of the abutting portion 2. A direction of a line that connects the two side walls is defined as the horizontal direction, and a direction perpendicular to the horizontal direction and away from the fourth rigid housing 212 is defined as the vertical direction. In such an arrangement, when the third rigid housing 211 wobbles along the horizontal direction, an abutting force is produced at the two side walls, and along the vertical direction, a seam is between the third rigid housing 211 and the fourth rigid housing 212. The longer the seam along this direction is, the more difficult it becomes to separate the third rigid housing 211 and the fourth rigid housing 212 after adhesive bonding, thereby ensuring that the two housings are bonded more firmly and reliably. Besides, two side surfaces of the third rigid housing 211 are complete flat planes, such that an antenna or a touch circuit may be arranged without extending across housings, thereby providing sufficient space for arranging the antenna and the touch circuit and facilitating assembly. Since the second flexible body 213 only covers the fourth rigid housing 212, the U-shaped structural arrangement ensures that the second flexible body 213 does not extend to touch regions on the side surfaces of the third rigid housing 211, thereby avoiding more severe wear of the rubber layer caused by touch operations and preventing delamination.

In some embodiments, referring to FIG. 17, at least one of the side walls of the U-shaped structure is a mounting base, with an antenna and/or a touch circuit board mounted thereon. By configuring at least one of the side walls as the mounting base, it ensures that, when an antenna or a touch circuit is arranged, it does not need to extend across different housings, thus providing sufficient space for arranging the antenna and the touch circuit and facilitating assembly. Since the second flexible body 213 only covers the fourth rigid housing 212, the U-shaped structural arrangement ensures that the second flexible body 213 does not extend to the touch regions on the side surfaces of the third rigid housing 211, thereby avoiding more severe wear of the rubber layer caused by touch operations and preventing delamination.

In some embodiments, both the third rigid housing 211 and the fourth rigid housing 212 are provided with a circular side wall and a semicylindrical side surface (also referred to as a connecting wall), forming a structure similar to an L-shape. Bottom surfaces of the third rigid housing 211 and the fourth rigid housing 212 face each other, and the semicylindrical side surfaces of the two housings complement each other to form a complete cylindrical cavity. That is, the connecting wall of the third rigid housing 211 and the connecting wall of the fourth rigid housing 212 are spliced together to form an annular peripheral wall of the abutting portion 2. Such an arrangement not only retains an intact side wall to provide a location for mounting the antenna and/or the touch circuit board, but also simplifies the assembly process, thereby improving assembly efficiency. The side wall of the third rigid housing 211 may be used as the mounting base for mounting the antenna and/or the touch control circuit board, and the side wall of the fourth rigid housing 212 may also be used as the mounting base for mounting the antenna and/or the touch control circuit board. One of the side walls may be used as the mounting base, or both the side walls may be used as the mounting base.

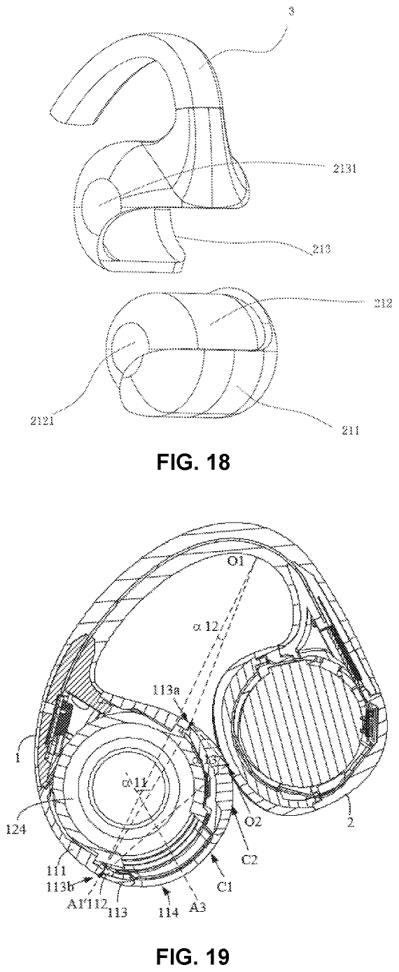

In some embodiments, referring to FIG. 18, the third rigid housing 211 and the fourth rigid housing 212 both have a cover buckle-shaped structure, at least one of the side walls of the third rigid housing 211 being spliced with at least one of the side walls of the fourth rigid housing 212 to form the mounting base, and the second flexible body 213 covers at least a portion of the mounting base.

In some embodiments, referring to FIG. 18, the third rigid housing 211 and the fourth rigid housing 212 may also be formed as an integrated structure, with the second flexible body 213 covering the fourth rigid housing 212. The second flexible body 213 includes a side wall 2131, and the side wall 2131 partially covers a side wall 2121 of the fourth rigid housing 212.

In some embodiments, the second flexible body 213 covers the fourth rigid housing 212 and the ear hook 3, and is integrally injection-molded with the fourth rigid housing 212 and the ear hook 3. This manufacturing method allows the second flexible body 213 to encapsulate a joint surface between the fourth rigid housing 212 and the ear hook 3, thereby preventing the joint surface from being exposed and improving both the reliability and aesthetics of the headset.

In some embodiments, referring to FIG. 1 and FIG. 15, in a natural state, the sound production portion 1 and the abutting portion 2 abut against each other, and the first flexible body 113 and the second flexible body 213 remain in contact. The two flexible bodies are in mutual contact to maintain a preload force, and when removed from the wearing state, the contact between the two flexible bodies cushions the impact between the sound production portion 1 and the abutting portion 2.

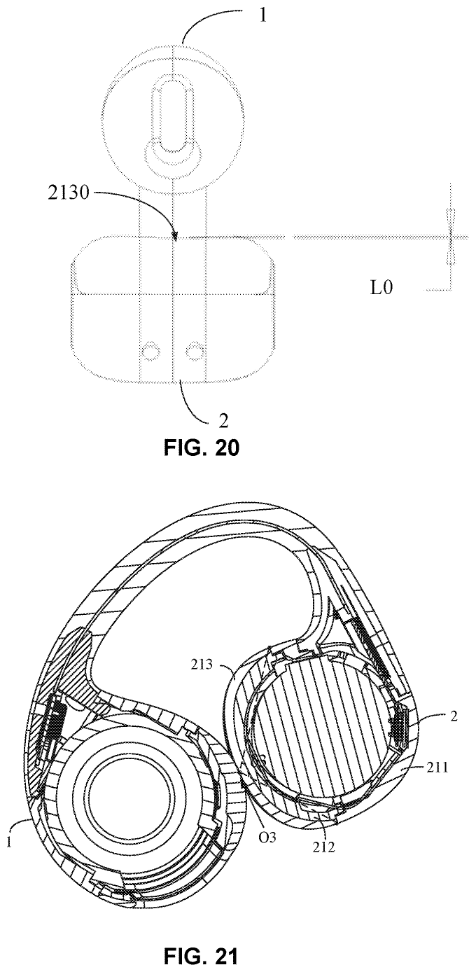

In some embodiments, referring to FIG. 1 and FIG. 20, in a natural state, the outer wall of the second flexible body 213 includes a concave surface 2130 disposed toward the first flexible body 113, and when the ear-clip earphone 100 is in a natural state, the first flexible body 113 contacts at least a portion of the concave surface 2130. The concave surface is designed to adapt to the shape of the soft tissue behind the human ear and the soft tissue of a head region opposite to the human ear, thereby increasing the contact area, reducing pressure, and enhancing wearing comfort. In addition, the contact between the sound production portion 1 and the concave surface 2130 can also reduce the impact force caused by the sudden transition from the wearing state to the natural state.

In some embodiments, on a cross-section that is perpendicular to the length direction of the second housing 21, a depth L0 of the concave surface 2130 is in a range of 0.07 to 0.25. For example, the length L0 is 0.07, 0.1, 0.15, 0.20, or 0.25. Setting the depth of the concave surface 2130 in such a manner can adapt to the shape of the soft tissue behind the human ear and the soft tissue of the head region opposite to the human ear, thereby increasing the contact area, reducing pressure, and enhancing wearing comfort.

In some embodiments, the second housing 21 includes an elongated strip structure. On a cross-section that is perpendicular to the length direction of the second housing 21 and passes through the midpoint along the length direction, an outer wall of the concave surface 2130 is recessed inwardly toward the interior of the second housing 21.

In other embodiments, the second housing 21 includes an elongated strip structure. On a cross-section that is perpendicular to the length direction of the second housing 21 and passes through the midpoint along the length direction, the second flexible body 213 has a shape that is thinner in the middle and thicker at two ends. This arrangement causes the curvature radius of the second flexible body 213 on the side facing the human ear to better adapt to the ear shape, increasing the contact area between the second housing 21 and the ear, and reducing the pressure exerted by the earphone on the ear.

In some embodiments, referring to FIG. 15, the second housing 21 includes an elongated strip structure. On a cross-section that is perpendicular to the length direction of the second housing 21, an angle δ1 between lines that connect two ends of the second flexible body 213 (i.e., two endpoints on an outer contour line of the second flexible body 213) and a centroid of the second accommodation cavity 210, respectively, is greater than or equal to 160 degrees. For example, the angle δ1 is 160 degrees, 165 degrees, 170 degrees, or 175 degrees. If the range (angle) covered by the second flexible body is too small, the rigid housing may come into contact with the wearer's skin in the wearing state, resulting in insufficient comfort.

In some embodiments, the second housing 21 includes an elongated strip structure. On a cross-section that is perpendicular to the length direction of the second housing 21, the angle δ1 between the lines that connect the two endpoints of the outer contour line of the second flexible body 213 and the centroid of the second accommodation cavity 210, respectively, is greater than or equal to 160 degrees or is greater than or equal to 145 degrees and less than 160 degrees. For example, the angle δ1 is 145 degrees, 150 degrees, 160 degrees, 165 degrees, 170 degrees, or 175 degrees. If the range (angle) covered by the second flexible body is too small, the rigid housing may come into contact with the wearer's skin in the wearing state, resulting in insufficient comfort.

In some embodiments, the second housing 21 includes an elongated strip structure. On a cross-section that is perpendicular to the length direction of the second housing 21, an arc length of the second flexible body 213 (e.g., an arc length of the outer contour line of the second flexible body 213) is greater than or equal to 18 mm. For example, the arc length is 18 mm, 20 mm, 22 mm, 24 mm, or 25 mm. If the arc length of the outer contour line of the second flexible body 213 is too small, the rigid housing may come into contact with the wearer's skin in the wearing state, resulting in insufficient comfort.

In some embodiments, the second housing 21 includes an elongated strip structure. On a cross-section that is perpendicular to the length direction of the second housing 21, the arc length of the outer contour line of the second flexible body 213 is greater than or equal to 18 mm, or greater than or equal to 12 mm and less than 18 mm. For example, the arc length is 12 mm, 14 mm, 16 mm, 18 mm, 20 mm, 22 mm, 24 mm, or 25 mm. If the arc length of the outer contour line of the second flexible body 213 is too small, the rigid housing may come into contact with the skin of the wearer in the wearing state, resulting in insufficient comfort.

In some embodiments, referring to FIG. 2, the ear hook 3 includes a support rib 31 and a third flexible body 32. The third flexible body 32 wraps around the support rib 31, and the second flexible body 213 and the third flexible body 32 form an integrally molded structure. Such an arrangement eliminates a parting line between the ear hook 3 and the abutting portion 2, providing a smoother transition and enhancing the stability of the connection between the components.

In some embodiments, the second flexible body 213 and the third flexible body 32 are arranged separately and are not in contact with each other. In this way, the preparation of the third flexible body 32 and the second flexible body 213 can be separated, which reduces process complexity. In other embodiments, the support rib 31 of the ear hook 3 may also be omitted.

In some embodiments, referring to FIG. 15, the second housing 21 includes an elongated strip structure. On a cross-section that is perpendicular to the length direction of the second housing 21, on the outer wall of the second flexible body 21, there are a first point Q1, a second point Q2, and a third point Q3 that are distributed sequentially along the arc length of the second flexible body 213. A distance between the first point and the centroid of the second accommodation cavity 210 and a distance between the third point and the centroid of the second accommodation cavity 210 are both greater than a distance between the second point and the centroid of the second accommodation cavity 210. Such an arrangement can adapt to the shape of the soft tissue behind the human ear and the soft tissue of the head region opposite to the human ear, thereby increasing the contact area, reducing pressure, and enhancing wearing comfort.

In some embodiments, referring to FIG. 15, the second housing 21 includes an elongated strip structure. On a cross-section that is perpendicular to the length direction of the second housing 2, the second point is located at the midpoint of the outer wall of the second flexible body 213. Such an arrangement can adapt to the shape of the soft tissue behind the human ear and the soft tissue of the head region opposite to the human ear, thereby increasing the contact area, reducing pressure, and enhancing wearing comfort.

In some embodiments, referring to FIG. 15, the second housing 21 includes an elongated strip structure. On a cross-section that is perpendicular to the length direction of the second housing 21, an angle between a line that connects the first point and the centroid of the second accommodation cavity 210 and a line that connects the second point and the centroid of the second accommodation cavity 210 is equal to an angle between the line that connects the second point and the centroid of the second accommodation cavity 210 and a line that connects a third point and the centroid of the second accommodation cavity 210. Such an arrangement can adapt to the shape of the soft tissue behind the human ear and the soft tissue of the head region opposite to the human ear, thereby increasing the contact area, reducing pressure, and enhancing wearing comfort.

In some embodiments, referring to FIG. 15, a distance between the first point and the centroid of the second accommodation cavity 210 is equal to a distance between the third point and the centroid of the second accommodation cavity 210. Such an arrangement can adapt to the shape of the soft tissue behind the human ear and the soft tissue of the head region opposite to the human ear, thereby increasing the contact area, reducing pressure, and enhancing wearing comfort.

In some embodiments, a difference between the thickness of the second flexible body 213 at the first point and the thickness of the second flexible body 213 at the second point is in a range of 0.2 mm to 0.5 mm, and/or a difference between the thickness of the second flexible body 213 at the third point and the thickness of the second flexible body 213 at the second point is in a range of 0.2 mm to 0.5 mm. Such an arrangement can adapt to the shape of the soft tissue behind the human ear and the soft tissue of the head region opposite to the human ear, thereby increasing the contact area, reducing pressure, and enhancing wearing comfort.

In some embodiments, a difference between a thickness D14 of the second flexible body 213 at the first point Q1 and a thickness D15 of the second flexible body 213 at the second point Q2 is in a range of 0.2 mm to 0.5 mm or less than or equal to 0.2; and/or, a difference between a thickness D16 of the second flexible body 213 at the third point Q3 and the thickness D15 of the second flexible body 213 at the second point Q2 is in a range of 0.2 mm to 0.5 mm or less than or equal to 0.2. Such an arrangement can adapt to the shape of the soft tissue behind the human ear and the soft tissue of the head region opposite to the human ear, thereby increasing the contact area, reducing pressure, and enhancing wearing comfort.

In some embodiments, referring to FIG. 15, the thickness D14 of the second flexible body 213 at the first point is in a range of 1.4 mm to 1.7 mm, and/or the thickness D15 of the second flexible body 213 at the second point is in a range of 1.0 mm to 1.3 mm, and/or the thickness D16 of the second flexible body 213 at the third point is in a range of 1.4 mm to 1.7 mm. The direction of the thickness is perpendicular to the normal direction of the outer wall of the second flexible body 213. Such an arrangement can adapt to the shape of the soft tissue behind the human ear and the soft tissue of the head region opposite to the human ear, thereby increasing the contact area, reducing pressure, and enhancing wearing comfort.

In some embodiments, referring to FIG. 15, the thickness D14 of the second flexible body 213 at the first point is in a range of 1.4 mm to 1.7 mm or greater than or equal to 0.3 mm and less than or equal to 1.4 mm; and/or, the thickness D15 of the second flexible body 213 at the second point is in a range of 1.0 mm to 1.3 mm or greater than or equal to 0.2 mm and less than or equal to 1.3 mm; and/or, the thickness D16 of the second flexible body 213 at the third point is in a range of 1.4 mm to 1.7 mm or greater than or equal to 0.3 mm and less than or equal to 1.4 mm. The direction of the thickness is perpendicular to the normal direction of the outer wall of the second flexible body 213. Such an arrangement can adapt to the shape of the soft tissue behind the human ear and the soft tissue of the head region opposite to the human ear, thereby increasing the contact area, reducing pressure, and enhancing wearing comfort.

In some embodiments, referring to FIG. 15, an angle δ2 between the line that connects the first point and the centroid of the second accommodation cavity 210 and the line that connects the third point and the centroid of the second accommodation cavity 210 is in a range of 165 degrees to 175 degrees. For example, the angle δ2 is 165 degrees, 168 degrees, 172 degrees, or 175 degrees. Such an arrangement can adapt to the shape of the soft tissue behind the human ear and the soft tissue of the head region opposite to the human ear, thereby increasing the contact area, reducing pressure, and enhancing wearing comfort.

In some embodiments, the angle δ2 between the line that connects the first point and the centroid of the second accommodation cavity 210 and the line that connects the third point and the centroid of the second accommodation cavity 210 is in a range of 165 degrees to 175 degrees or greater than or equal to 90 degrees and less than 165 degrees. For example, the angle δ2 is 90 degrees, 100 degrees, 110 degrees, 120 degrees, 130 degrees, 140 degrees, 150 degrees, 165 degrees, 168 degrees, 172 degrees, or 175 degrees. Such an arrangement can adapt to the shape of the soft tissue behind the human ear and the soft tissue of the head region opposite to the human ear, thereby increasing the contact area, reducing pressure, and enhancing wearing comfort.

In some embodiments, the second accommodation cavity 210 is a battery cavity, and the abutting portion 2 includes a battery, which is accommodated in the battery cavity.

In some embodiments, the ear hook 3 includes the symmetry plane A2 along the length direction of the ear hook 3, and the symmetry plane A2 and the outermost circular edge of the end surface of the second flexible body 213 intersect at two intersection points. There is a third reference point O3 on an outer wall of the abutting portion 2, and a distance between the third reference point O3 and the outer wall of the sound production portion 1 is the shortest. An angle δ3 between lines that connect the third reference point O3 and the two intersection points, respectively, is in a range of 80 degrees to 130 degrees. For example, the angle δ3 is 80 degrees, 90 degrees, 100 degrees, 110 degrees, 120 degrees, or 130 degrees.

In some embodiments, when the ear-clip earphone 100 is in a natural state (i.e., no external force is applied), the sound production portion 1 and the abutting portion 2 are spaced apart on the symmetry plane A2, the third reference point O3 refers to an endpoint, on the abutting portion 2, of the shortest connection line between the sound production portion 1 and the abutting portion 2. In some embodiments, when the earphone is in a natural state (i.e., no external force is applied), the sound production portion 1 and the abutting portion 2 abut against each other on the symmetry plane A2, the third reference point O3 refers to a midpoint of an arc segment, on the symmetry plane A2, of a contact region between the sound production portion 1 and the abutting portion 2.

By configuring the wrapping angle of the second flexible body 213 in this manner, the contact region between the human ear and the second housing 21 under most users or a standard head model can be entirely covered by the second flexible body 213, thereby ensuring wearing comfort, while also reserving more space for the third rigid housing 211 so that the internal cavity volume is not excessively occupied by the silicone region.

Referring to FIGS. 23-32, it should be noted that the angle notations such as α, β, and γ in the following description correspond to the angle notations in FIGS. 23-32.

It should be noted that the materials of the first flexible body 113 and the second flexible body 213 are not limited to silicone, rubber, elastic resin, polyurethane, polydimethylsiloxane, PVC, TPE, or the like, and any flexible material may be used.

In some embodiments, the output volume of the earphone at the ear canal opening of the wearer can be adjusted by varying the position of the sound outlet hole in the sound production portion. Generally, the greater the output volume of the earphone at the ear canal opening is, the louder the sound experienced by the wearer at the same output power may be, thereby reducing the power consumption of the earphone and minimizing sound leakage.

In some embodiments, as shown in FIG. 23, the first housing 11 is provided with the sound outlet hole 114, and sound produced by the sound production assembly 12 is output outwardly through the sound outlet hole 114. The ear hook 3 includes the symmetry plane A2 along the length direction of the ear hook 3, and an angle α between a central axis of the sound outlet hole 114 and the symmetry plane A2 is in a range of 15 degrees to 45 degrees. In the wearing state, the sound outlet hole 114 is located on a lower side of the symmetry plane A2. By setting the angle α between the central axis of the sound outlet hole 114 and the symmetry plane A2 of the ear hook in a range of 15 degrees to 45 degrees, the sound outlet hole 114 can be better directed toward the ear hole in the wearing state, thereby improving the listening effect.

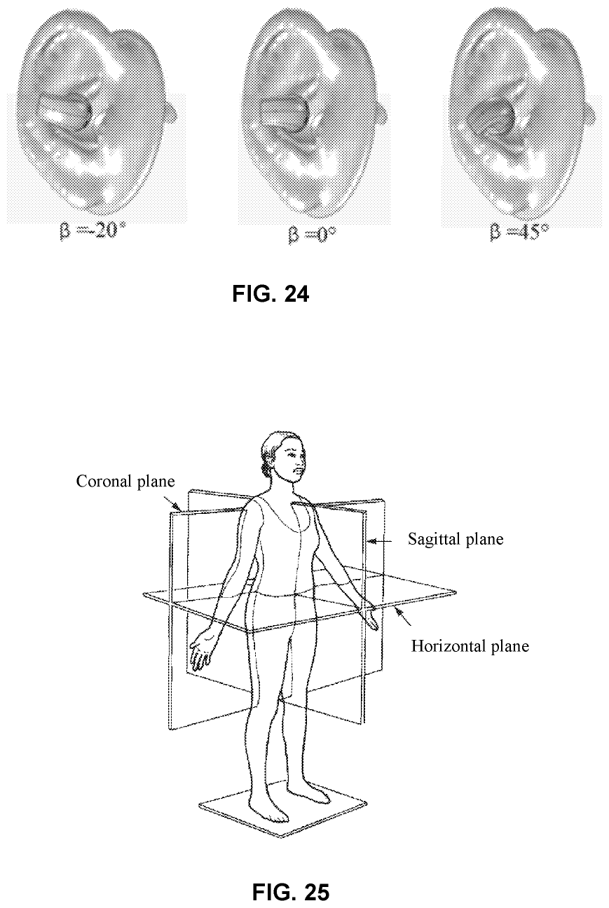

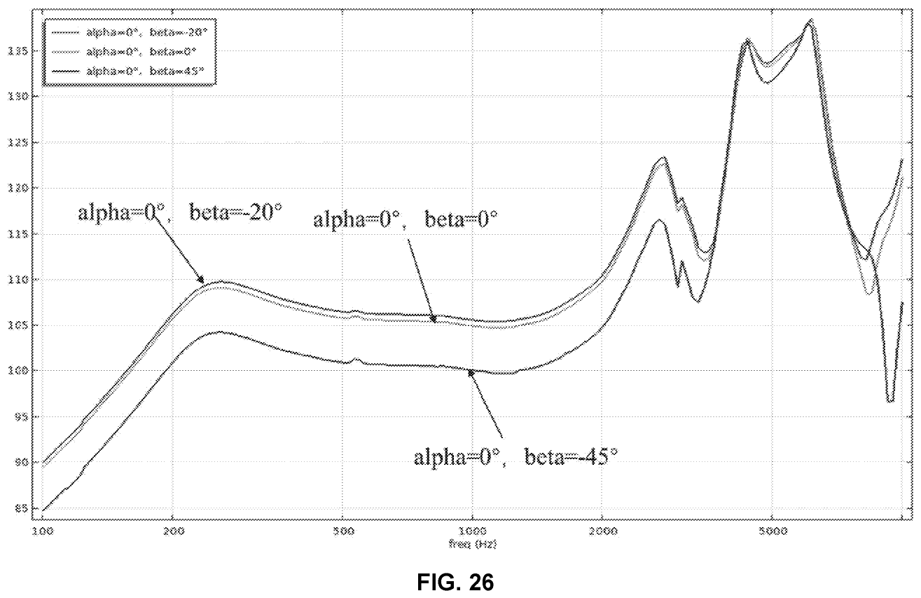

In some embodiments, the sound outlet hole 114 may be configured as an strip shape. Referring to FIG. 23 and FIG. 24, the sound outlet hole is disposed perpendicular to the symmetry plane of the ear hook (i.e., a long axis of the sound outlet hole is perpendicular or substantially perpendicular to (with a deviation within 15 degrees) the symmetry plane of the ear hook, which may also be referred to as that the sound outlet hole is disposed longitudinally). In this case, the sound outlet hole 114 may be disposed on a portion of the first rigid housing 111 that is not covered by the first flexible body 113, to prevent the sound outlet hole 114 from extending across both the first rigid housing 111 and the second rigid housing 112. An angle α is defined as an angle between the normal line (i.e., the central axis of the sound outlet hole 114) of the sound outlet hole extending outward from the sound production portion 1 and the symmetry plane A2 of the ear hook. An angle β is defined as an angle between the symmetry plane A2 and the horizontal plane of the human body. As shown in FIG. 26, by fixing the angle α as 0 degrees (i.e., the symmetry plane passes through the central axis of the sound outlet hole) and adjusting the angle β to −20 degrees, 0 degrees, and 45 degrees, respectively, corresponding frequency response curves of the earphone output at the ear canal opening were measured, where the horizontal axis represents the output frequency of the earphone (Hz), and the vertical axis represents the measured sound pressure level (dB).

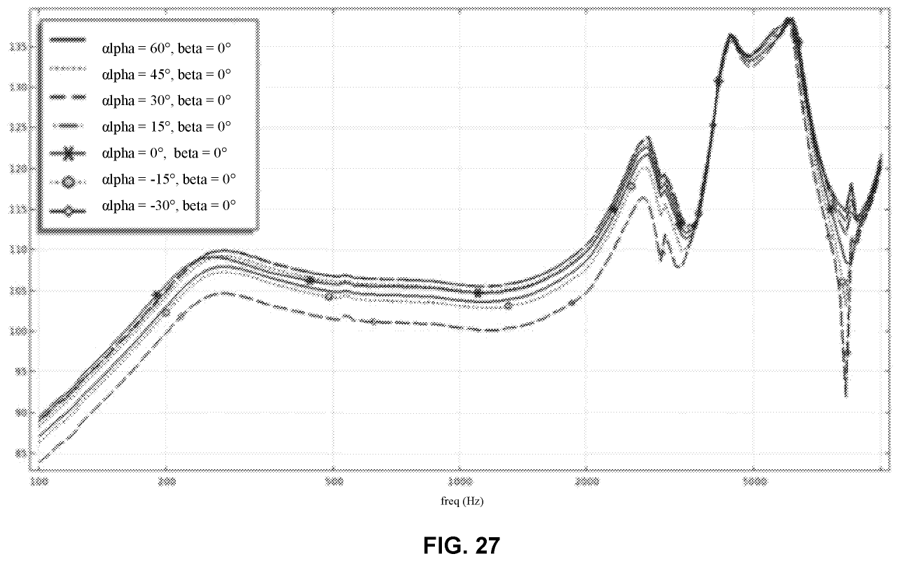

Further, referring to FIG. 27, by fixing the angle β as 0 degrees (i.e., a wearing state in which the symmetry plane is parallel to the horizontal plane of the human body) and adjusting the angle α to −30 degrees, −15 degrees, 0 degrees, 15 degrees, 30 degrees, 45 degrees, and 60 degrees, respectively, corresponding frequency response curves of the earphone output at the ear canal opening were measured. It can be seen from the figure that, when α is in a range of 15 degrees to 45 degrees, the measured frequency response curves of the earphone exhibit the highest sound pressure level (SPL), indicating the maximum output volume.

In addition, when the ear-clip earphone is worn, β is usually in a range of 0 degrees to 30 degrees due to the gravity influence. Therefore, by arranging the sound outlet hole as that, when β is 0 degrees (i.e., the wearing state in which the symmetry plane is parallel to the horizontal plane of the human body), the angle α between the normal line (i.e., the central axis of the sound outlet hole 114) of the sound outlet hole and the symmetry plane A2 is in a range of 15 degrees to 45 degrees, the listening volume can be increased in wearing scenarios in which β is in a range of 0 degrees to 30 degrees (equivalent to adjusting the curve corresponding to α=0° and β=45° in FIG. 26 to the curve corresponding to α=0° and β=0°)

In some embodiments, the sound outlet hole 114 is configured as an strip shape, and includes a first end 1141 and a second end 1142 spaced apart along the length direction of the sound outlet hole 114. In a wearing state, the first end 1141 is disposed toward the ear hole, and a distance L1 between an outer wall of the first housing 11 at the second end 1142 and an inner wall surface of the concha cavity is smaller than a distance L1 between an outer wall of the first housing 11 at the first end 1141 and the inner wall surface of the concha cavity.

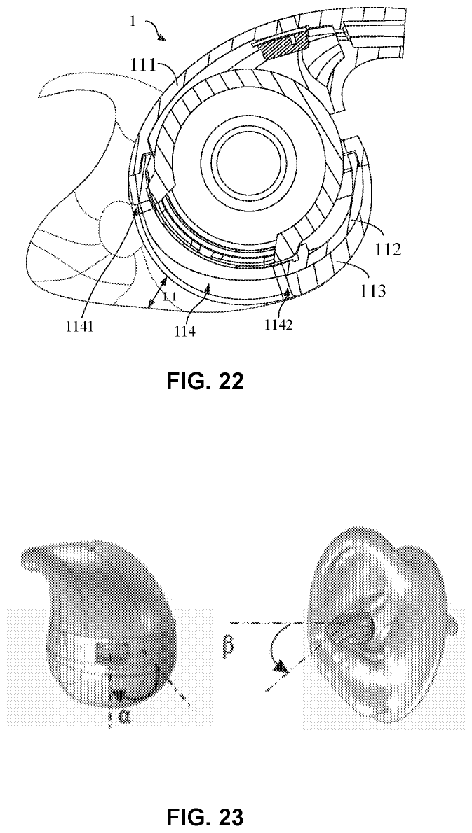

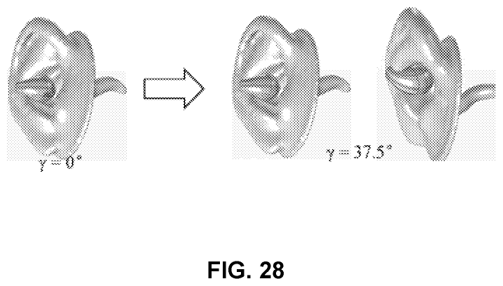

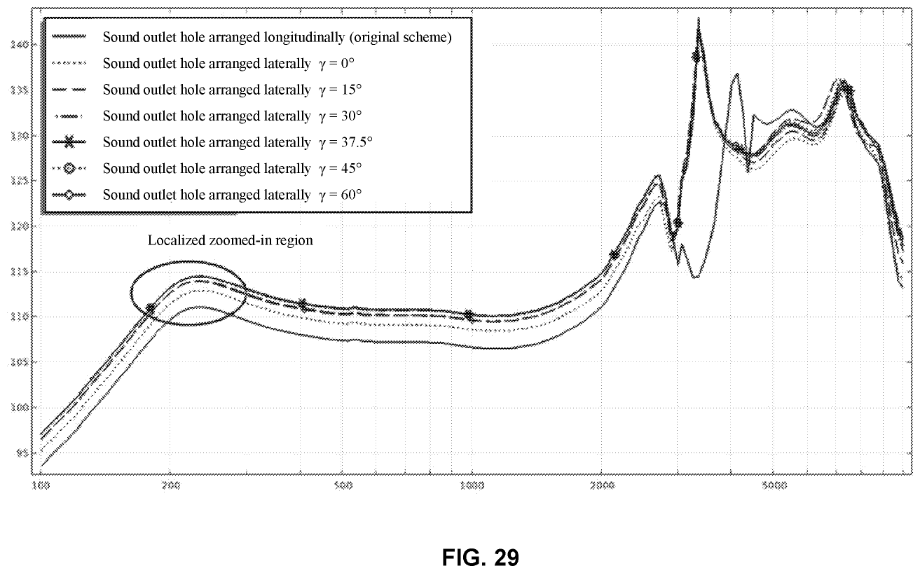

Further, referring to FIG. 28, the sound outlet hole 114 may be arranged laterally (i.e., the long axis of the sound outlet hole is parallel or substantially parallel to the symmetry plane with a deviation within 15 degrees). In this case, as shown in FIG. 22, the sound outlet hole 114 may be disposed on the second rigid housing 112 and the first flexible body 113 to prevent the sound outlet hole 114 from extending across both the first rigid housing 111 and the second rigid housing 112. As described in connection with above, the sound outlet hole arranged longitudinally is rotated 90 degrees about its central symmetrical axis, the normal line of the sound outlet hole pointing outward from the sound production portion is then rotated toward the midpoint direction of a shorter side of the sound outlet hole that is closer to the ear canal opening, wherein an angle swept during this rotation is defined as γ. As shown in FIG. 29, the angle γ was adjusted to 0 degrees, 15 degrees, 30 degrees, 37.5 degrees, 45 degrees, 60 degrees, and frequency response curves of the sound output at the ear canal opening were measured, respectively. As shown in the figure, as the angle γ of the sound outlet hole increases (i.e., the sound outlet hole is rotated inward toward the ear canal), the measured SPL first increases and then decreases. When the angle γ is in a range of 30 degrees to 45 degrees, the measured SPL at the ear canal opening is higher than those under other ranges, and the SPL does not change significantly within this range (the SPL curves corresponding to the angle γ being 30 degrees, 37.5 degrees, and 45 degrees are close). Therefore, the value of the angle γ may be defined in a range of 30 degrees to 45 degrees.

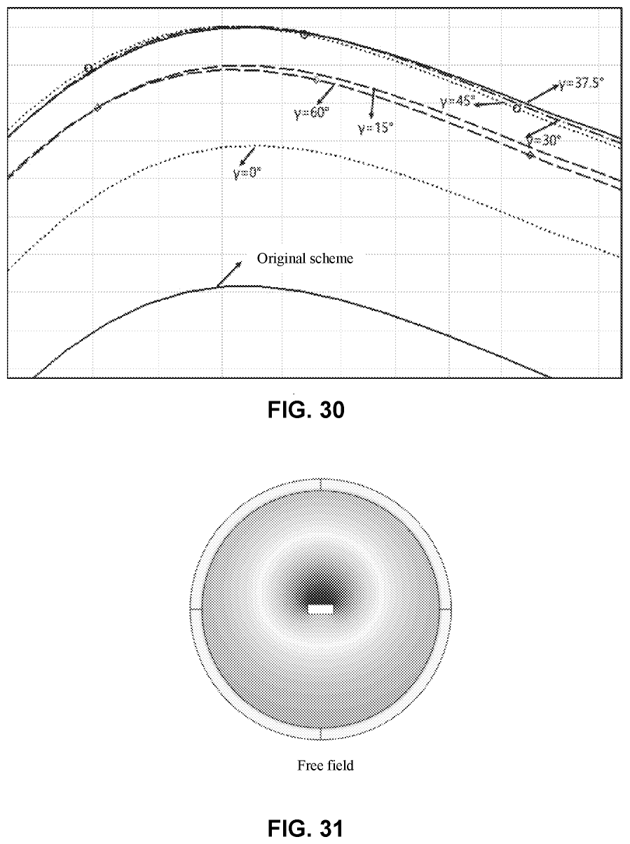

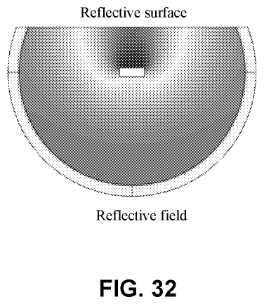

The trend of the SPL output by the earphone in FIG. 29 and FIG. 30 can be explained by the “horn effect”. As shown in FIG. 31 and FIG. 32, the shading of the gray area represents the magnitude of the SPL. When a point sound source in space radiates sound to its surroundings, if a reflective surface exists near the propagation direction, certain positions close to the sound source in the reflective field may experience sound reinforcement due to interference and diffraction between the reflected waves and the direct waves, compared with a free field.

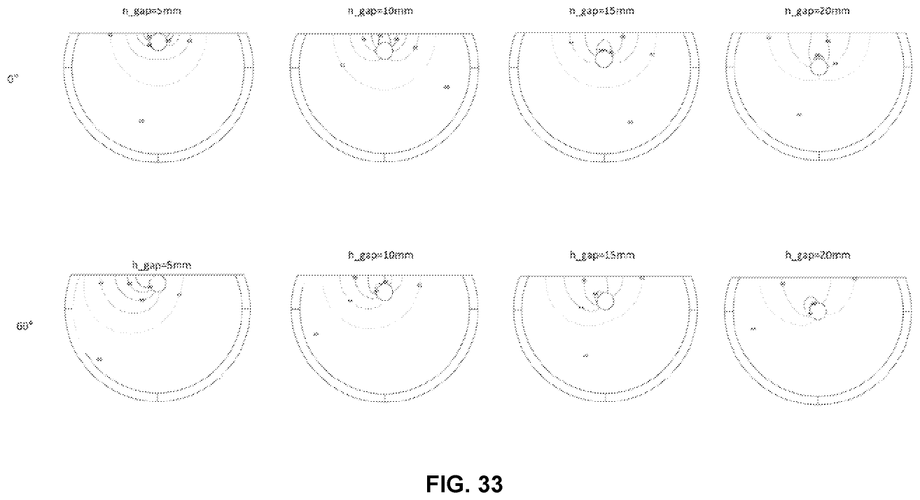

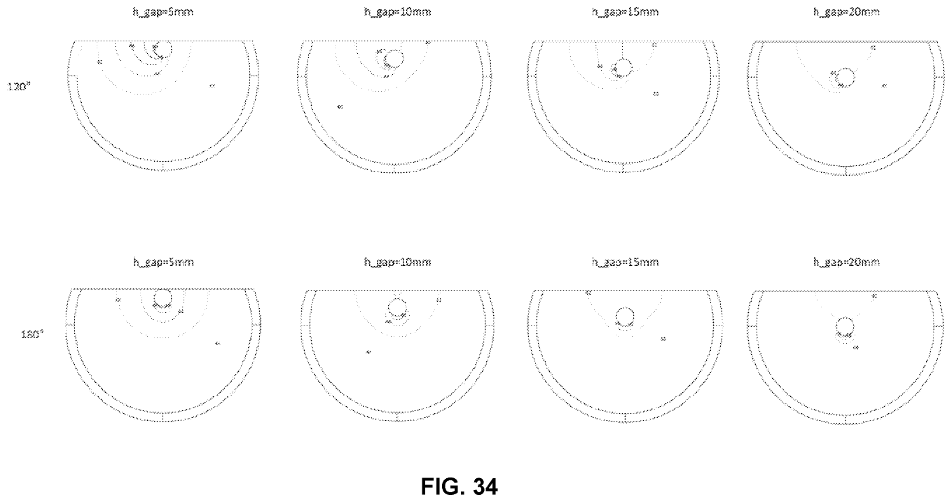

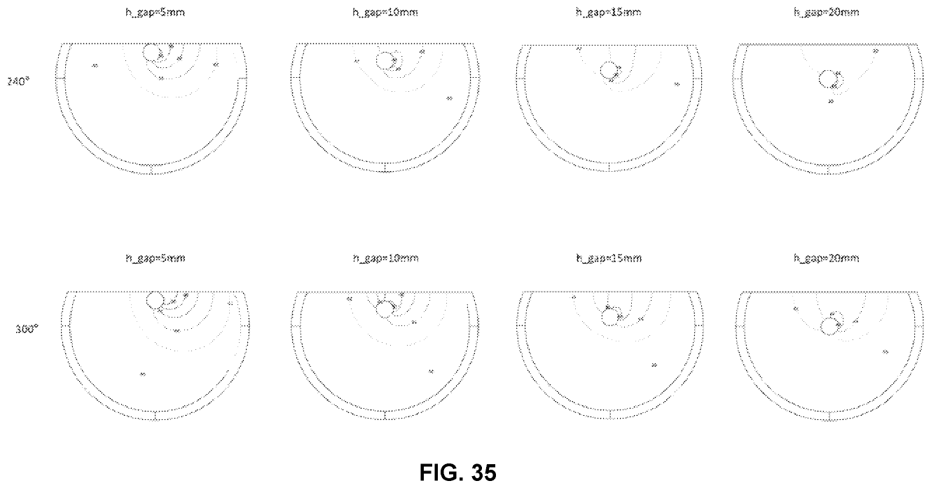

A straight-line distance between the center of the sound production portion and the reflective surface is defined as h-gap, and an angle between the normal line of the sound outlet hole pointing outward from the sound production portion and a line that connects the center of the sound production portion and the reflective surface is defined as an angle θ. FIGS. 33-35 show simulation results when the values of h-gap are 5 mm, 10 mm, 15 mm, and 20 mm, and the values of the angle θ are 0 degrees, 60 degrees, 120 degrees, 180 degrees, 240 degrees, and 300 degrees, respectively, with a source signal of 2000 Hz. The results are presented as contour maps of sound pressure level. The results show that the closer the sound source is to the reflective surface, the greater the sound pressure near the reflective surface; when the normal line of the sound outlet hole pointing outward from the sound production portion is inclined toward the reflective surface (the angle θ are 60 degrees and 300 degrees, respectively), a maximum sound pressure level is produced on one side (with the largest area of the high-sound-pressure region), and the high-sound-pressure region on that side may be regarded as a listening position.

In the present disclosure, the sound production portion may be regarded as a point sound source enclosed by the housing, and the concha cavity located opposite to the sound outlet hole disposed on the housing may be regarded as a reflective surface. Accordingly, when the sound outlet hole is positioned close to the concha cavity and is disposed offset to one side, the listening position at the ear canal hole can obtain a maximum sound pressure level.

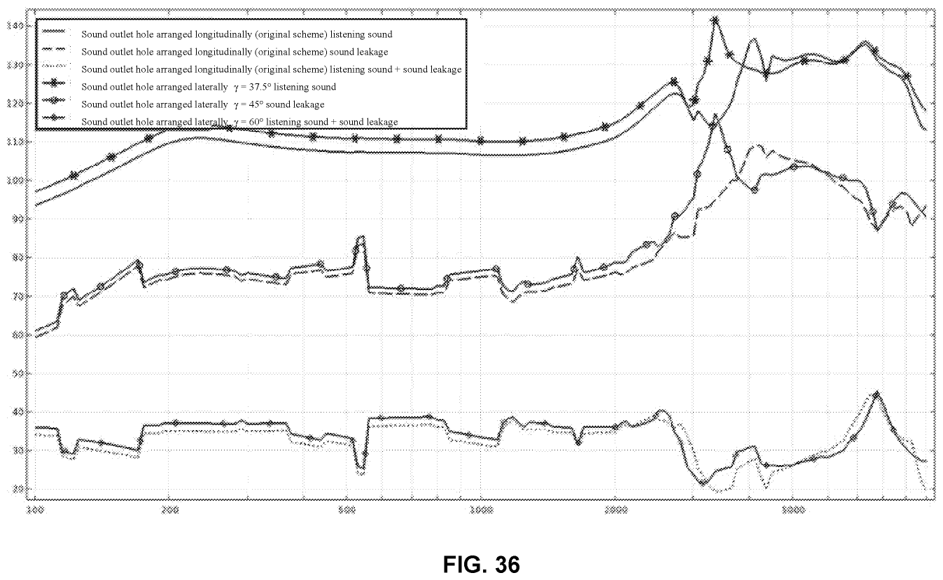

FIG. 36 is a diagram illustrating sound leakage curves of a sound outlet hole at different positions. In the test environment, the term “sound leakage” refers to the sound measured at a point located 30 mm away from the ear canal along a direction perpendicular to the sagittal plane of the human body, and the sound level at this point can be measured using a microphone. Under the conditions of the scheme optimization, the scheme of the sound outlet hole arranged laterally (i.e., the angle γ is 37.5 degrees) reduces the sound leakage by approximately 2 dB compared with the original scheme of the sound outlet hole arranged longitudinally.

The above application of specific examples to illustrate the present disclosure is only used to aid in the understanding of the present disclosure and is not intended to limit the present disclosure. For those skilled in the art to which this application belongs, a number of simple deductions, deformations, or substitutions may also be made based on the ideas of the present disclosure.

1. An ear-clip earphone, comprising a sound production portion, an abutting portion, and an ear hook, wherein
the sound production portion inserts into a concha cavity of a wearer, the abutting portion abuts a rear side of an ear of the wearer, the ear hook connects the sound production portion and the abutting portion, the abutting portion and the sound production portion are configured to clamp the ear-clip earphone onto a helix of the wearer;
the sound production portion includes a first housing and a sound production assembly, the first housing includes a first accommodation cavity, and the sound production assembly is disposed within the first accommodation cavity;
the first housing is provided with a sound outlet hole, sound produced by the sound production assembly is output via the sound outlet hole; and
the ear hook includes a symmetry plane along a length direction of the ear hook, an angle between a central axis of the sound outlet hole and the symmetry plane is in a range of 15 degrees to 45 degrees, and in a wearing state, the sound outlet hole is located on a lower side of the symmetry plane.

2. The ear-clip earphone of claim 1, wherein in the wearing state, an angle between the symmetry plane and a horizontal plane of the wearer is in a range of 0 degrees to 30 degrees.

3. The ear-clip earphone of claim 1, wherein the sound production assembly includes an intermediate mounting bracket and two speakers, wherein
the two speakers are mounted on the intermediate mounting bracket;
a sound transmission channel is between diaphragms of the two speakers; and
the central axis of the sound outlet hole passes through the sound transmission channel.

4. The ear-clip earphone of claim 3, wherein a protruding structure is disposed on one side of the intermediate mounting bracket, and the sound transmission channel is arranged on the protruding structure.

5. The ear-clip earphone of claim 4, wherein an inner wall of the first housing is provided with a groove for accommodating the protruding structure.

6. The ear-clip earphone of claim 1, wherein the sound production assembly includes a speaker, and an angle between a mounting plane on which a diaphragm of the speaker is located and the symmetry plane is less than 10 degrees.

7. The ear-clip earphone of claim 1, wherein the sound outlet hole is arranged in a strip shape.

8. The ear-clip earphone of claim 1, wherein the first housing includes a first rigid housing, a second rigid housing, and a first flexible body, wherein
the first rigid housing is connected to the ear hook;
the second rigid housing is close to the concha cavity in the wearing state; and
the first flexible body covers an outer wall of the second rigid housing.

9. The ear-clip earphone of claim 1, wherein the sound outlet hole is arranged in a strip shape and includes a first end and a second end spaced apart along a length direction of the sound outlet hole, wherein in the wearing state, the first end is disposed toward an ear hole, and a distance between an outer wall of the first housing at the second end and an inner wall surface of the concha cavity is smaller than a distance between an outer wall of the first housing at the first end and the inner wall surface of the concha cavity.

10. The ear-clip earphone of claim 9, wherein the length direction of the sound outlet hole is parallel or substantially parallel to the symmetry plane.

11. The ear-clip earphone of claim 9, wherein
the sound outlet hole is disposed on the second rigid housing and the first flexible body.

12. The ear-clip earphone of claim 7, wherein a length direction of the sound outlet hole is perpendicular or substantially perpendicular to the symmetry plane.

13. The ear-clip earphone of claim 7, wherein the sound outlet hole is disposed on the first rigid housing.

14. The ear-clip earphone of claim 8, wherein an outer wall of the first rigid housing is not covered by the first flexible body and is exposed.

15. The ear-clip earphone of claim 8, wherein the first flexible body extends from an outer side of the second rigid housing to an outer side of the first rigid housing and covers a portion of the outer wall of the first rigid housing, so that the remaining portion of the outer wall of the first rigid housing is exposed.

16. The ear-clip earphone of claim 8, wherein an end surface of the first flexible body abuts an end surface of the first rigid housing.

17. The ear-clip earphone of claim 8, wherein there is a gap between an end surface of the first flexible body and an end surface of the first rigid housing.

18. The ear-clip earphone of claim 8, wherein there is a gap between an end surface of the first rigid housing and an end surface of the second rigid housing, and a portion of the first flexible body extends into the gap and is clamped and fixed between the end surface of the first rigid housing and the end surface of the second rigid housing.

19. The ear-clip earphone of claim 8, wherein the sound production assembly is mounted on the second rigid housing, and one end of the sound production assembly facing the first rigid housing protrudes from the second rigid housing.

20. The ear-clip earphone of claim 8, wherein the first rigid housing includes a region facing the ear hole when worn, and at least a portion of the sound outlet hole is disposed within the region.
